(19) United States
(12) Patent Application Publication
(10) Pub. No.: US 2006/0008574 A1
(43) Pub. Date: Jan. 12, 2006

(54) Galactosyl isomalt, method for production and use thereof

(76) Inventors: Alireza Haji Begli, Ramsen (DE); Michael Klingeberg, Grunstadt (DE); Markwart Kunz, Worms (DE); Ralf Mattes, Stuttgart (DE); Sven Schroder, Hamburg (DE); Joachim Thiem, Hamberg (DE); Manfred Vogel, Neuleiningen (DE)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/515,488

(22) PCT Filed: Jun. 6, 2003
(86) PCT No.: PCT/EP03/05999

§ 371 Date: Jul. 25, 2005

(30) Foreign Application Priority Data
Jun. 7, 2002 (DE) 102 25 242.4

(51) Int. Cl. A23G 3/00

(52) U.S. Cl. 426/658

(57) ABSTRACT

This invention concerns a method for preparation of galactosyl isomalt and galactosyl isomalt, the products and intermediate products that are obtained, and their use.

This invention concerns β-galactosylated saccharides or saccharide alcohols, especially compositions or mixtures containing galactosyl isomalt and compositions and mixtures containing galactosyl isomaltulose, a method for producing them and the resulting products and intermediate products as well as their use in foodstuffs, foods, semi-luxury foods (“Genussmittel”—foods that are consumed not for their nutritional value, but rather for the pleasure they provide) and animal feeds and for or as drugs.

Foodstuffs, semi-luxury foods and animal feeds serve first of all the nourishment and well-being of the human and animal consumer. Besides these two aspects of foods, a health-promoting function is increasingly expected from foods and semi-luxury foods. Foods and semi-luxury foods on the one hand should promote and maintain health, while on the other hand they should ward off harmful effects and optionally have a prophylactic effect against diseases. Such health-promoting foodstuffs and semi-luxury foods by definition develop their effect chiefly in the digestive tract. The ingested nutrients are broken down and partially absorbed in the anterior digestive tract. Hard-to-digest carbohydrates pass into the large intestine and are available to the microbial intestinal flora there.

Short-chain fatty acids like butyric acid (butyrate) are enzymatically formed from undigested carbohydrates by saccharolytic bacteria in the large intestine. Butyric acid is the dominant source of energy for epithelial cells in the colon, affects cellular proliferation and differentiation and plays a central role as a growth factor for healthy intestinal epithelium and in the maintenance of the mucosal barrier in the colon. Short-chain fatty acids like butyric acid and its salts (butyrate) contribute to the detoxification of potential mutagenic metabolites in the large intestine and counteract oxidative stress, for example, via the induction of gene expression of protective proteins like the intestinal glutathione S-transferase or the inhibition of ornithine decarboxylase. Glutathione (GSH) is a cysteine-containing tripeptide and the most common thiol compound in mammalian cells. GSH is a substrate for the enzyme glutathione S-transferase and GSH peroxidase, which catalyze the detoxification of xenobiotic compounds and reactions to inhibit reactive oxygen molecules and other free radicals. As a substrate of glutathione S-transferase (GST), GSH converts to the corresponding disulfide GSSG through reversible oxidation. Glutathione acts as an antioxidant and, because of this, is in particular a buffer system for the redox state of the cell. The GSTs form one of the most important detoxification systems of the cells, especially during phase II of cell division. The detoxification takes place through the transmission of glutathione to electrophilic compounds, which arise, for example, during the metabolization of carcinogens. Through the GST-catalyzed nucleophilic attack by glutathione on electrophilic substrates, their reactivity with respect to cellular macromolecules is highly reduced. GSTs thus can highly reduce the effectiveness of a number of chemical carcinogens. For this reason, GSTs play an important physiological role in protecting against oxidative stress and against the diseases that go hand in hand with it, especially cancer diseases. Compounds like polycyclic aromatic hydrocarbons, phenol antioxidants, reaction oxygen molecules, isothiocyanates, trivalent arsenic compounds, barbiturates and synthetic glucocorticoids can induce the GST activities, and the genes encoding GST enzymes become activated (Hays and Pulford, 1995). The GST induction mainly takes place via various transcription mechanisms. The regulation ranges of GST-encoding genes contain elements to which said substances bind and can induce gene transcription. Nutrient components, for example, phytochemical substances, can also induce GST activities, where in particular GST forms of the π class are induced in the intestinal region. The GST induction in the intestinal tract by nutrient components is therefore viewed as a mechanism for prevention of intestinal cancer diseases (Peters and Roelofs, Cancer Res., 52 (1992), 1886-1890). Hard-to-digest or indigestible nutrient components are of particular importance for GST induction, i.e., nutrient fibers or roughages that are resistant to digestion by human enzymes, but that become fermented in the large intestine. These include certain carbohydrates like pectin, “guar gum” (guar bean flour) and resistant starch, which are first fermented in the intestinal tract by the bacterial flora of the large intestine to form short-chain fatty acids, especially acetic acid, propionic acid and butyric acid (Bartram et al., Cancer Res., 53 (1993), 3283-3288).

Moreover, short-chain fatty acids like butyric acid have a controlling effect on the induction of specific genes and the modification of cell cycle regulation proteins, antibacterial peptides and signal cascades. High butyric acid concentrations in the large intestine, especially in the posterior large intestine regions, support a healthy intestinal environment and a healthy intestinal epithelium, improve symptoms of ulcerative inflammations of the colon and are protective in colon carcinogenesis, i.e., they serve as substances that reduce the risk of cancer of the large intestine.

For this reason, it is desirable to promote intestinal flora that have a positive effect on human or animal health and, moreover, to achieve production of large amounts of butyric acid, especially in the posterior segments of the large intestine. This can be achieved through the supply of suitable substrates to improve the living conditions for the health-promoting intestinal flora and conditions for substrates for microbial formation of butyric acid, especially in the posterior regions of the large intestine. Substances or substance mixtures that, as components of foodstuffs or semi-luxury foods, selectively promote the growth and/or the activity of specific health-promoting intestinal bacteria, in particular bifidobacteria and lactobacilli, are called prebiotics. Prebiotics promote the growth and/or the activity of health-promoting intestinal bacteria and, as a rule, are carbohydrates that cannot be digested by the enzymes of the gastrointestinal tract.

The actual amount of digestion-resistant and fermentable nutrient fibers or roughages in the diet is dependent on many factors, for example, the kind of food and the manner of preparing it. Most foodstuffs, feeds or semi-luxury foods are low in roughages. On the other hand, vegetables, certain varieties of fruit, nuts, seeds and especially unrefined cereal products are rich in roughages. One way of compensating the deficiency of roughages resulting from food processing or a low-roughage diet, and especially protecting against cancer diseases and infectious diseases via the intake of food, lies in enriching foods with ideally indigestible but readily fermentable roughages. However, most of the roughages currently used to enrich foods has a number of significant disadvantages and does not satisfy the expectations made with respect to prevention and/or treatment of cancer diseases, especially of the large intestine, and of infectious diseases. It was found in long-term studies, at the US National Cancer Institute and the University of Arizona, among others, that a multiyear diet with roughage-rich foods, for example, with muesli products, clearly did not have an effect on the frequency of cancer of the large intestine. However, only roughages that cannot be fermented in the large intestine was used in these studies.

Not all saccharides that are known as prebiotics serve to provide the necessary fermentation products of the intestinal microflora, especially short-chain fatty acids like the advantageous butyric acid, preferably as butyrate, in the posterior intestinal segments. Known prebiotics like fructooligosaccharides that reach the large intestine are fermented there quite rapidly and completely. The short-chain fatty acids that are formed then are rapidly and nearly completely absorbed by the intestinal epithelial cells at the site of their origination. However, to make these fermentation products available in the posterior intestinal segments, it is necessary that the saccharides be fermented more slowly, so that sufficient substrate also gets into the posterior intestinal regions and becomes available for microbial fermentation. The very rapid fermentation of the known prebiotics also disadvantageously contains a higher risk for laxative effects and other gastrointestinal problems. Furthermore, the known prebiotics like inulin and oligofructose are disadvantageously characterized by the fact that when they are broken down by the intestinal microflora chiefly other short-chain fatty acids are formed, especially acetic acid, and they provide the advantageous butyric acid only to a very low extent and thus are only slightly butyrogenic and, therefore, do not represent substrates for the formation of butyric acid in the posterior regions of the large intestine.

Known prebiotics like fructooligosaccharides are also disadvantageously characterized by the fact that their industrial processability in food manufacturing in some cases leaves something to be desired. Insufficient solubility in water, for example, in the case of longer-chain carbohydrates like resistant starch, their low acid stability and their reactivity as partially reducing oligosaccharides contribute to their limited applicability. This is especially true when they are used in products that have a low pH.

For example, wheat bran is commonly used as an additive to low-roughage food. As was shown by studies of the incidence of colon tumors in rats, however, the use of wheat bran is hardly suitable for cancer prevention. Wheat bran, similar to cellulose, is hardly fermented by the flora of the large intestine. Rather, wheat bran and other cereal fibers mostly have a high fraction of the adhesive protein gluten and its toxic components, which lead to serious changes of the mucosa in the small intestine. The damage to the absorptive epithelium leads to a loss of digestive enzymes and to very serious morphological and functional disorders (malabsorption with disrupted absorption of all nutrients, including minerals, vitamins, etc., celiac disease).

On the other hand, β-galactosylated oligosaccharides satisfy said requirements imposed on an ideal roughage to a high degree and therefore have positive effects on the digestive organs and on the status of the immune system. For this reason, they would have a broad spectrum of use in the nutrient agent industry, especially in the field of health food and diet food. The actual use is, however, highly dependent on the availability of larger amounts of these galactose-containing oligosaccharides. The synthesis of β-galactosylated oligosaccharides by known chemical methods was developed within the last decade. To be sure, the known β-galactosylation methods involve multistep approaches, which require, for example, the introduction of protecting groups and their elimination in a later step. These methods therefore are not very useful for the production of β-galactosylated oligosaccharides on a large industrial scale. To overcome these difficulties, synthesis strategies were developed in which biological enzymes act as catalysts. To be sure, there are, for example, known alternative approaches that call for the use of glycosyl transferases, which likewise cannot be conducted on a large scale, since the availability of these transferases and their cofactors is highly limited at present. In addition, the nucleoside sugars needed for these approaches as galactosyl donor structures are likewise not available in larger amounts.

This invention is based on the technical problem of making available agents that are suitable for prevention of diseases, especially cancer of the large intestine, and do not have the disadvantages of the roughages known in the prior art, as well as improved and more economical methods for producing these agents.

This task is solved by making available a method for producing a composition that contains galactosylated hydrogenated isomaltulose and/or galactosylated nonhydrogenated isomaltulose, especially that consists thereof, where

a) at least one galactosyl donor dissolved in an aqueous solution is brought into contact with

b) at least one β-galactosidase and with

c) an aqueous solution of a mixture that contains hydrogenated isomaltulose, especially isomalt, and/or nonhydrogenated isomaltulose, in particular that consists thereof, and

a mixture containing galactosylated hydrogenated isomaltulose, in particular containing galactosyl isomalt, galactosyl isomalt composition (A) in the following, and/or containing galactosylated nonhydrogenated isomaltulose, i.e., galactosyl isomaltulose composition, is obtained.

The inventors surprisingly found that glycoside hydrolases, i.e., glycosidases like β-galactosidase that have transglycosylating properties, can also be advantageously used for the glycosylation of saccharides and saccharide alcohols, especially disaccharides and disaccharide alcohols. The known traditional function of these glycosidases consists of hydrolytic cleavage of glycosidic bonds. Through the derivatization of the substrates with higher leaving groups and the related altered kinetics of the enzyme/substrate bond, there surprisingly is a reversal of the enzymatic reaction, as part of a transglycosylation, i.e., formation of glycosidic bonds. It is especially advantageous that these glycosides are available in larger amounts and, in addition, enable the use of less complex glycosyl donor substrates like di- or trisaccharides.

Therefore, this invention makes available essentially a method for producing a galactosyl saccharide, in particular a galactosyl trisaccharide, or galactosyl saccharide alcohol, especially a galactosyl trisaccharide alcohol, which contains a galactosyl residue in the β position. In a first step, at least one galacosyl donor is mixed with a galactosyl acceptor, which is at least one saccharide and/or saccharide alcohol, especially a disaccharide and/or disaccharide alcohol, or a mixture containing at least one of these compounds, and, under the effect of a transglycosylating enzyme, namely at least one β-galactosidase, is brought into contact and reacted over a certain reaction time, preferably in an aqueous solution so that galactosyl residues are transferred from the galactosyl donor to the galactosyl acceptor. At least one galactosyl saccharide, at least one galactosyl saccharide alcohol and/or a mixture containing at least one of these compounds is formed as reaction product. The resulting product or product mixture is preferably, in accordance with the invention, further purified by means of conventional separation processes, according to requirement, and/or is preferably subjected to a catalytic hydrogenation.

In other variations, this invention concerns oligosaccharides like di-, tri-, tetra- and pentasaccharides, as well as monosaccharides and mixtures thereof, or their alcohols and mixtures thereof, as the saccharides.

Preferably, in accordance with the invention, the educt is (a) hydrogenated isomaltulose and/or (b) nonhydrogenated isomaltulose, and a mixture containing (a) galactosyl isomalt and/or (b) galactosyl isomaltulose is obtained as the product.

In connection with this invention, the term “isomaltulose or “nonhydrogenated isomaltulose,” on the one hand, is understood to mean the compound 6-O-α-D-glucopyranosyl-(1→6)-β-D-fructofuranose, hereinafter also called 6-O-α-D-glucopyranosyl fructose, and on the other hand, it is understood to be a mixture containing essentially 6-O-α-D-glucopyranosyl fructose. Isomaltulose is preferably obtained by enzymatic reaction from sucrose. In accordance with the invention, it is foreseen in a preferred embodiment that this educt mixture additionally contains other substances like sugar alcohols or sugars, especially oligosaccharides and/or disaccharides, for example, trehalulose or isomaltose, and/or monosaccharides, for example, fructose. Educt mixtures that consist predominantly of 6-O-α-D-glucopyranosyl fructose, especially more than 70, 80, 85, 90, 95 or 97 wt %, are preferred.

This invention therefore also provides that the reaction product β-D-galactopyranosyl-(1→3)-α-D-glucopyranosyl-(1→6)-D-fructose, β-D-galactopyranosyl-(1→4)-α-D-glucopyranosyl-(1→6)-D-fructose, and/or β-D-galactopyranosyl-(1→6)-α-D-glucopyranosyl-(1→6)-D-fructose, hereinafter called β-1,3-galactosyl isomaltulose, β-1,4-galactosyl isomaltulose, and β-1,6-galactosyl isomaltulose, respectively, or a mixture containing at least one of these galactosyl isomaltuloses is obtained from 6-O-α-D-glucopyranosyl-D-fructose or from a mixture containing 6-O-α-D-glucopyranosyl-D-fructose under the effect of a β-galactosidase. In each case according to the linkage of the galactosyl residue to the 6-O-α-D-glucopyranosyl fructose, the product, thus the galactosyl isomaltulose, contains β-1,3-galactosyl isomaltulose, β-1,4-galactosyl isomaltulose and/or β-1,6-galactosyl isomaltulose; in particular, the galactosyl isomaltulose is a composition of these β-1,3-, β-1,4-, and β-1,6-linked galactosyl isomaltuloses. It is provided in a preferred embodiment in accordance with the invention that the resulting product or product mixture additionally contain other galactosylated and/or nongalactosylated substances like sugar alcohols or sugars, especially oligosaccharides, disaccharides or monosaccharides or alcohols thereof. Product mixtures that consist of β-1,3-, β-1,4-, and β-1,6-linked galactosyl isomaltuloses or essentially consist of them, especially more than 70, 80, 85, 90, 95 or 97 wt %, are preferred.

Preferably, the hydrogenated isomaltulose used in accordance with the invention as educt is isomalt or an isomalt-containing mixture, which can preferably be synthesized from the hydrogenation of isomaltulose. In connection with this invention, the term “isomalt” is understood to mean a mixture containing 6-O-α-D-glucopyranosyl-(1→6)-D-sorbitol (6-O-α-D-glucopyranosyl-(1→6)-D-sorbitol), hereinafter 1,6-GPS, and 1-O-α-D-glucopyranosyl-(1→1)-D-mannitol, especially 1-O-α-D-glucopyranosyl-(1→1)-D-mannitol dihydrate, hereinafter 1,1-GPM, especially a nearly equimolar mixture of these two sugar alcohols, with the amount of 1,6-GPS in the nearly equimolar mixture being from about 44 wt % to about 56 wt % and the amount of 1,1-GPM correspondingly being from about 56 wt % to about 44 wt %. The invention, of course, also includes isomalt variations, i.e., mixtures with a ratio of 1,6-GPS to 1,1-GPM that deviates from a nearly equimolar ratio of the two sugar alcohols, for example, from 1 wt % 1,6-GPS to 99 wt % 1,1-GPM up to 99 wt % 1,6-GPS to 1 wt % 1,1-GPM, especially 1,6-GPS-enriched mixtures with a ratio of 57 wt % 1,6-GPS to 43 wt % 1,1-GPM up to 99 wt % 1,6-GPS to 1 wt % 1,1-GPM, or 1,1-GPM-enriched mixtures with a ratio of 1 wt % 1,6-GPS to 99 wt % 1,1-GPM up to 43 wt % 1,6-GPS to 57 wt % 1,1-GPM, as disclosed in DE 195 32 396 C2. Of course, it is provided in a preferred embodiment that this educt mixture additionally also contain other substances like sugar alcohols or sugars, for example, 1-O-α-D-glucopyranosyl-D-sorbitol, i.e., 1,1-GPS, mannitol, sorbitol and/or other mono-, di- or oligosaccharides. Educt mixtures that consist of 1,6-GPS and/or 1,1-GPM or that primarily contain these substances, especially more than 70, 80, 85, 90, 95 or 97 wt %, are preferred.

In accordance with the invention, the dimer sugar alcohols 1,6-GPS and/or 1,1-GPM are converted to trisaccharide alcohols (DP 3), thus to galactosylated 1,6-GPS and/or galactosylated 1,1-GPS or a mixture containing galactosylated 1,6-GPS and/or galactosylated 1,1-GPS, hereinafter called galactosyl isomalt composition (A). In each case according to the linkage of the galactosyl residue to the 1,6-GPS and/or 1,1-GPM, the product, thus the galactosyl isomalt composition, contains β-D-galactosyl-(1→3)-α-D-glucosyl-(1→6)-D-sorbitol(β-1,3-galactosyl-1,6-GPS) and/or β-D-galactosyl-(1→3)-α-D-glucosyl-(1→1 )-D-mannitol(β-1,3-galactosyl-1,1-GPM), β-D-galactosyl-(1→4)-α-D-glucosyl-(1→6)-D-sorbitol(β-1,4-galactosyl-1,6-GPS) and/or β-D-galactosyl-(1→4)-α-D-glucosyl-(1→1)-D-mannitol(β-1,4-galactosyl-1,1-GPM), and/or β-D-galactosyl-(1→6)-α-D-glucosyl-(1→6)-D-sorbitol(β-1,6-galactosyl-1,6-GPS) and/or β-D-galactosyl-(1→6)-α-D-glucosyl-(1→1)-D-mannitol(β-1,6-galactosyl-1,1-GPM). The reaction product preferably contains galactosyl lactose, glucose, isomalt, lactose, galactose and/or tetrasaccharides as other components.

In the galactosylation of hydrogenated isomaltulose, especially isomalt, that is preferred in accordance with the invention, the resulting galactosyl isomalt composition contains:

a) β-D-1,3-Galactosyl isomalt, i.e., β-D-galactosyl-(1→3)-α-D-glucosyl-(1→6)-D-sorbitol(β-1,3-galactosyl-1,6-GPS) and β-D-galactosyl-(1→3)-α-D-glucosyl-(1→1)-D-mannitol(β-1,3-galactosyl-1,1-GPM) as in formula (1),

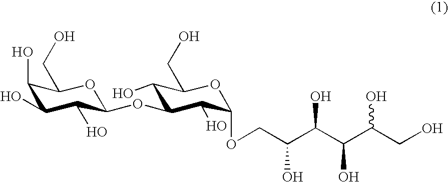

b) β-D-1,4-Galactosyl isomalt, i.e., β-D-galactosyl-(1→4)-α-D-glucosyl-(1→6)-D-sorbitol (β-1,4-galactosyl-1,6-GPS) and β-D-galactosyl-(1→4)-α-D-glucosyl-(1→1)-D-mannitol(β-1,4-galactosyl-1,1-GPM) as in formula (2),

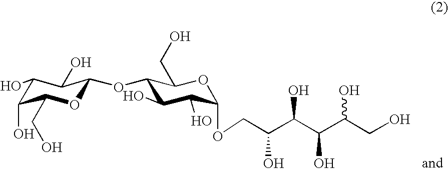

c) β-D-1,6-Galactosyl isomalt, i.e., β-D-galactosyl-(1→6)-α-D-glucosyl-(1→6)-D-sorbitol(β-1,6-galactosyl-1,6-GPS) and β-D-galactosyl-(1→6)-α-D-glucosyl-(1→1)-D-mannitol(β-1,6-galactosyl-1,1-GPM) as in formula (3),

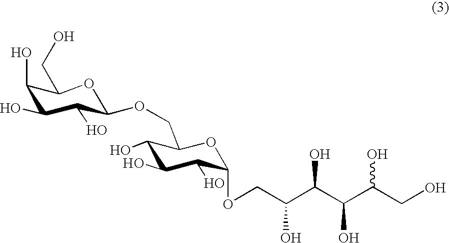

Each of these formulas (1)-(3) is representative both for the sorbitol and also for the mannitol epimer or diastereomer of the relevant β-galactosyl isomalt isomer, which are also objects of the invention. The invention therefore also includes each individual one of the two diastereomers (mannitol/sorbitol) of the galactosyl isomalts in isolated form and in each case the mixtures of each of the two diastereomers in isolated form, as well as the mixture of all sorbitol and mannitol epimers of the three linkage products.

In the galactosylation of nonhydrogenated isomaltulose that is preferred in accordance with the invention, the resulting galactosyl isomaltulose composition contains:

a) β-1,3-Galactosyl isomaltulose (β-D-galactopyranosyl-(1→3)-α-D-glucopyranosyl-(1→6)-D-fructose) as in formula (4),

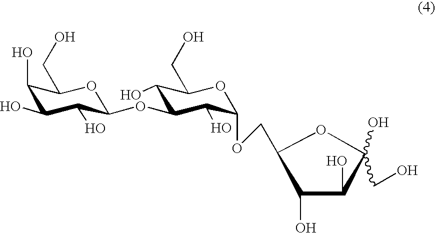

b) β-1,4-Galactosyl isomaltulose(β-D-galactopyranosyl-(1→4)-α-D-glucopyranosyl-(1→6)-D-fructose) as in formula (5),

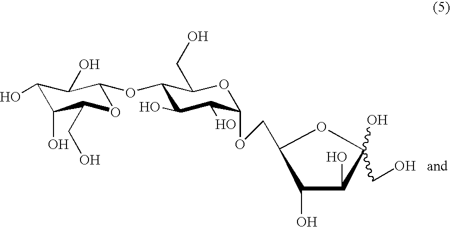

c) β-1,6-Galactosyl isomaltulose (β-D-galactopyranosyl-(1→6)-α-D-glucopyranosyl-(1→6)-D-fructose) as in formula (6),

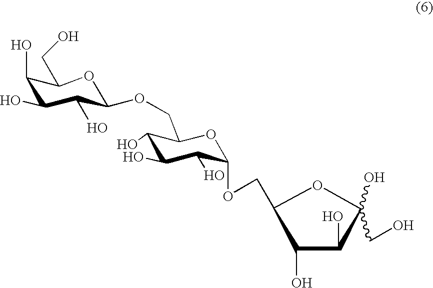

Therefore, the invention also concerns mixtures of two or three of said compounds (4), (5) and/or (6) as well as the compounds in isolated form.

In a preferred embodiment the ratio of galactosyl donor to galactosyl acceptor is from 1 part galactosyl donor to 1 part galactosyl acceptor (1:1) up to 1 part galactosyl donor to 5 parts galactosyl acceptor (1:5), with respect to % by weight. The invention provides in an especially preferred embodiment that lactose is the galactosyl donor.

In another preferred embodiment the invention provides that the minimum of one enzyme, namely the β-galactosidase, is in free, preferably dissolved, and/or in immobilized form. It is provided that the enzyme is in a completely or partially purified form or even as a raw extract. It is also provided that the enzyme is of natural origin or is synthetic, where it is preferably prepared in accordance with the invention by means of recombinant methods or other substantially known methods. Finally, it is provided that the enzyme is a deviation, mutant, mutein, modification or derivative of a natural enzyme.

In accordance with the invention, especially advantageously, it becomes possible to control the composition of the galactosyl saccharide-containing or galactosyl saccharide alcohol-containing mixtures obtained in accordance with the invention in a predetermined way, through the choice of the experiment conditions, in particular in each case according to the choice of the specifically used β-galactosidase: the method in accordance with the invention enables the preparation of a galactosylated product, where it contains galactosyl trisaccharide or galactosyl trisaccharide alcohol linked in the β-1,3-β-1,4- and/or β-1,6-positions in an adjustable composition.

β-Galactosidase from bull testicle is used in a preferred embodiment of this invention. When using β-galactosidase from bull testicle, one obtains a galactosylation product that has an elevated content of β-(1,3)-linked galactosyl product, especially β-(1,3)-galactosyl-1,6-GPS and/or β-(1,3)-galactosyl-1,1-GPM and/or β-(1,3)-galactosyl isomaltulose, especially more than 50 wt % β-1,3-galactosyl product (with respect to DP 3 products).

In another preferred embodiment β-galactosidase in the form of the enzyme BgaB from Bacillus stearothermophilus KVE39, BgaT from Thermus brockianus IT1360 and BglT from Thermus thermophilus TH125 are used, where likewise a galactosylation product with an especially high content of said β-(1,3)-galactosyl product, in particular more than 50 wt % β-1,3-galctosyl product (with respect to DP 3 products) is obtained (all three microorganisms and the β-galactosidases contained in them are described in Fridjonsson, O., Watzlawick, H., Mattes, R. (2000), The structure of the alpha galactosidase gene loci in Thermus brockianus ITI360 and Thermus thermophilus TH125. Extremophiles 4:23-33 and Ganter, C., Böck, A., Buckel, P., Mattes, R. (1988), Production of a thermostable, recombinant alpha galactosidase suitable for raffinose elimination from sugar beet syrup, J. Biotechnol. 8:301-310).

In another preferred embodiment it is provided for the galactosylation to use a β-galactosidase from Bacillus circulans, where a product with an elevated content of β-(1,4)-galactosyl product, especially β-(1,4)-galactosyl-1,6-GPS and/or β-(1,4)-galactosyl-1,1-GPM and/or β-(1,4)-galactosyl isomaltulose is obtained; in particular, the amount of β-(1,4)-galactosyl product is more than 50 wt % (with respect to DP 3 products).

Finally, in another preferred embodiment it is provided for the galactosylation to use a β-galactosidase from Aspergillus oryzae, where a product with an elevated content of β-(1,6)-galactosyl product, especially β-(1,6)-galactosyl-1,6-GPS and/or β-(1,6)-galactosyl-1,1-GPM and/or β-(1,6)-galactosyl isomaltulose is obtained; in particular, the amount of β-(1,6)-galactosyl product is more than 50 wt % (with respect to DP 3 products).

In variations that are especially preferred in accordance with the invention, β-galactosidase encoding genes deriving from said bacterial organisms are integrated into expression vectors, inserted into host strains that themselves do not produce β-galactosidases, preferably E. coli, and production strains that produce the desired β-galactosidases are obtained. Since the enzymes that have formed preferably derive from thermostable organisms, they can be purified from the raw extracts of, preferably, E. coli by heat precipitation of the host proteins. The resulting raw extracts in particular contain from 60-90 wt % of the prepared enzyme.

Preferably, in accordance with the invention this method is carried out at an acid pH, in particular at a pH of 4.0-6.5, preferably in a buffered solution. It is provided that the galactosylation reaction be carried out preferably for a period of 1-50 h at a temperature of preferably 30-55° C., where, in particular, a period of 40-50 h at a temperature of 33-40° C. is planned when using β-galactosidase from bull testicle, a period of 1-3 h at a temperature of 50-60° C. is foreseen when using β-galactosidase from Bacillus circulans, and a period of 1-3 h at a temperature of 25-35° C. is foreseen when using β-galactosidase from Aspergillus oryzae.

In accordance with the invention it is preferably provided that physical and/or chemical separation methods that enable a separation of reaction products with a desired degree of polymerization be used for the separation and isolation of all of said reaction products. Preferably, in accordance with the invention the selected reaction products are purified or enriched by means of a chromatographic step in a substantially known way. In connection with this invention, a “chromatographic separation method” is understood to be any physical method in which a separation of substances takes place by distribution between a stationary and a mobile phase, where preferably adsorption, ionic interactions, polar or apolar interactions, size exclusion, and complexing are preferred as the basis of the separation mechanisms. In a preferred embodiment of the invention, the separation of the reaction products takes place by using gel permeation methods, which are also called exclusion chromatography, molecular sieve chromatography or gel filtration methods. “Gel permeation” is understood to mean the operation in which a division according to molecular size takes place on the basis of a sieve effect as a consequence of the migration of molecules through a gel matrix that has a pore structure. In one variation, substances like polydextrans, polyacrylamide, agarose, etc., are used as the gel matrix for separation of selected reaction products from the reaction mixture. In a particularly preferred variation, a cation exchanger which has been loaded in particular with calcium ions (Ca²⁺) is used for separation of accompanying components.

In another especially preferred embodiment the galactosyl saccharide composition, especially galactosyl isomaltulose composition, obtained from the conversion in accordance with the invention of a saccharide and/or saccharide-containing mixture, especially isomaltulose or an isomaltulose-containing mixture, in the first step of the method in accordance with the invention is converted essentially to a galactosyl saccharide alcohol-containing mixture, especially a galactosyl isomalt-containing mixture, hereinafter called galactosyl isomalt composition (B), in an additional subsequent second step of the method by means of chemical hydrogenation, preferably as a catalytic hydrogenation using hydrogenation catalysts, in the presence of hydrogen (H₂).

In accordance with the invention it is also preferably provided that, in the galactosyl isomaltulose composition that is obtained by galactosylation by one of said methods in the first step as the product, which is intended for the preferred hydrogenation as educt in accordance with the invention, individual components be enriched or removed before the hydrogenation by chromatographic separation.

Preferably, in accordance with the invention a galactosyl saccharide composition obtained from said method is hydrogenated by dissolving the mixture or the individual substance in an aqueous medium, preferably water, in a concentration from 20 wt % to 40 wt %, preferably 30 wt %. It is provided in accordance with the invention that the pH of the aqueous solution be adjusted to 6-8 using suitable agents, in particular in a buffered solution. In a preferred embodiment of the invention, the pH of the solution of the compound(s) to be hydrogenated is adjusted to 7.8 by the addition of sodium hydroxide. It is provided in accordance with the invention that the hydrogenation take place at a temperature from 40-140° C., especially 60-80° C., preferably 70° C. It is also provided in accordance with the invention that the hydrogenation take place in the presence of hydrogen, where, in a preferred embodiment of the method in accordance with the invention, the hydrogen that is used has an elevated pressure of 50-230 bar, especially 100-200 bar, preferably about 150 bar. Preferably, the reaction mixture is continuously stirred during the hydrogenation. In particular in accordance with the invention it is provided that the hydrogenation take place over a period of at least 2-5 h, preferably at least 4 h. It is provided in accordance with the invention that the hydrogenation be carried out continuously. In one variation the hydrogenation is carried out semicontinuously or batchwise. The hydrogenation in accordance with the invention is preferably carried out in a fixed bed process and/or in a suspension process.

Especially preferably, in accordance with the invention the hydrogenation takes place as a catalytic hydrogenation using a catalyst. In a preferred embodiment of the invention, a mixture of a pure Raney metal and a Raney metal alloy is used as catalyst, where the Raney metal is preferably nickel, copper, cobalt or iron. The Raney metal alloy is preferably an alloy of nickel, copper, cobalt and/or iron with at least one component like aluminum, tin or silicon that is in particular leachable. In another preferred embodiment of the invention the catalyst used for hydrogenation includes as active component one or more metals of the VIII side group of the periodic system on an inert support. Preferably, ruthenium, platinum, palladium, rhodium and/or mixtures thereof are used as active component. The inert catalyst support preferably consists of carbon (activated carbon), aluminum oxide, zirconium oxide, silicon oxide, titanium dioxide, and/or mixtures thereof.

Preferably, in accordance with the invention the galactosyl isomaltulose composition is converted in the hydrogenation essentially to galactosylated 1,6-GPS and galactosylated 1,1-GPM, or a mixture containing these compounds, hereinafter called galactosyl isomalt composition (B). In each case according to the linkage of the galactosyl residue to the 1,6-GPS and/or 1,1-GPM, the hydrogenation product galactosyl isomalt composition (B) occurs as β-1,3-galactosyl-1,6-GPS and/or β-1,3-galactosyl-1,1-GPM, β-1,4-galactosyl-1,6-GPS and/or β-1,4galactosyl-1,1-GPM, and/or as β-1,6-galactosyl-1,6-GPS and/or β-1,6-galactosyl-1,1-GPM. Preferably, the sugar alcohols galactosyl isomalt, galactosyl lactitol, galactosyl sorbitol as well as sorbitol, isomalt, lactitol and/or galactitol arise as other components of the galactosyl isomalt composition (B).

In a preferred variation the hydrogenation product in accordance with the invention, i.e., the galactosyl isomalt composition (B), is further purified or enriched as described, in particular to obtain galactosyl lactitol- and/or galactosyl isomalt-enriched products, especially purified or isolated galactosyl lactitol and/or galactosyl isomalt.

The invention also concerns the reaction products and intermediate products prepared or obtained in accordance with the invention, especially galactosyl isomalt-containing mixtures like the galactosyl isomalt composition (A) and the galactosyl isomalt composition (B) and/or galactosyl isomaltulose-containing mixtures like the galactosyl isomaltulose composition.

An object of this invention is a galactosyl isomaltulose composition prepared by galactosylation of an educt mixture containing isomaltulose, which preferably contains 4-30 wt %, especially 5-15 wt % β-1,6-galactosyl isomaltulose (6), preferably 6-60 wt %, especially 10-40 wt % β-1,4-galactosyl isomaltulose (5) and preferably 15-90 wt %, especially 25-60 β-1,3-galactosyl isomaltulose (4), in particular that consists thereof. In accordance with the invention galactosyl isomaltulose compositions enriched in β-1,3-galactosyl product that contain more than 50 wt % β-1,3-galactosyl isomaltulose with respect to the DP 3 products are preferred.

Another object of this invention is a galactosyl isomalt composition (A) prepared by galactosylation of an educt mixture containing hydrogenated isomaltulose, especially isomalt, a galactosyl isomalt composition (B), prepared by hydrogenation of an educt mixture containing galactosylated isomaltulose, especially said galactosyl isomaltulose composition, which preferably contains 4-30 wt %, especially 5-15 wt %, β-1,6-galactosyl isomalt, preferably 6-60 wt %, especially 10-40 wt % β-1,4-galactosyl isomalt and preferably 15-90 wt %, especially 25-60 wt % β-1,3-galcatosyl isomalt, in particular that consists thereof. The data in wt % in each case refer to the total content of DP 3 products in the dry substance of the reaction product, i.e., galactosyl isomalt. In accordance with the invention galactosyl isomalt compositions enriched in β-1,3-galactosyl product that contain more than 50 wt % β-1,3-galactosyl isomalt with respect to DP 3 products are preferred.

The invention also concerns said products that contain at least one additional sugar and/or sugar alcohol, for example, monosaccharides (DP 1) or their alcohols, disaccharides (DP 2) or their alcohols, and tetrasaccharides (DP 4) or their alcohols.

In a preferred embodiment the galactosyl isomaltulose composition contains from 1-45 wt %, especially 2-30 wt % galactosyl isomaltulose, also galactose as well as glucose, lactose, isomaltulose and/or galactosyl lactose.

In another preferred embodiment the galactosyl isomalt composition (A) obtained by galactosylation of an isomalt-containing mixture contains, in addition to 1-45 wt %, especially 2-30 wt % galactosyl isomalts, galactose, glucose, lactose, isomalt and/or galactosyl lactose. In one variation the galactosyl isomalt composition (A) also contains galactosylated 1,1-GPS. Other objects of the invention are the isolated components obtained from the galactosyl isomalt composition (A) and/or the galactosyl isomaltulose composition by separation, especially galactosyl lactose.

In another preferred embodiment the galactosyl isomalt composition (B) obtained by the hydrogenation of a galactosyl isomaltulose-containing mixture contains from 1-45 wt %, especially 2-30 wt % galactosyl isomalt and galactitol, sorbitol, lactitol, isomalt, galactosyl sorbitol and/or galactosyl lactitol. Other objects of the invention are also the isolated components obtained from the galactosyl isomalt composition (B) preferably by separation, especially galactosyl isomalt, galactosyl lactitol and galactosyl sorbitol. In one variation the galactosyl isomalt composition (B) also contains galactosylated 1,1-GPS.

Said individual substances, mixtures and compositions in accordance with the invention are preferably in completely or partially purified form and are preferably also used in this form. In an alternative embodiment the mixtures and compositions in accordance with the invention are not separated to remove reaction by-products and are also used in this form. The mixtures and compositions in accordance with the invention are preferably used, for example, in dried form, as suspension or in aqueous solution.

The amount of the components with the degree of polymerization of 1 (DP 1) in the mixtures and compositions in accordance with the invention is preferably from 2-30 wt %, the amount of the products with degree of polymerization of 2 (DP 2) is preferably from 30-90 wt %, and the amount of products with degree of polymerization of 4 (DP 4) is preferably from 0-5 wt %. The enrichment of individual reaction products, especially DP 3 products, galactosyl isomalt or galactosyl isomaltulose and/or galactosyl lactose or galactosyl lactitol and/or galactosyl sorbitol by chromatographic separation is provided in accordance with the invention.

The invention also concerns isolated and purified mixtures consisting of β-3-galactosyl isomalt, β-1,4-galactosyl isomalt and β-1,6-galactosyl isomalt, or mixtures essentially containing them, for example, in an amount of ≧80, ≧90, ≧95 wt % dry substance. The invention likewise concerns isolated β-1,3-galactosyl isomalt. The invention also concerns isolated β-1,4-galactosyl isomalt. In addition, the invention also concerns isolated β-1,6-galactosyl isomalt.

The isolation of the compounds in accordance with the invention is preferably achieved with a preparative chromatographic system. The DP 3 ranges that are preferably obtained by means of gel permeation chromatography (see Example 4, below) can in a preferred embodiment be separated into the desired individual components by means of preparative HPAEC, for example, under the following conditions:

Separation columns: 2× Carbopac PA 1, each 22 mm×250 mm, anion exchanger, Dionex Co.

Flow rate: 30 mL/min

Input volume: 0.6 mL

Detection: Pulsed amperometric detector (gold electrode), aliquot of eluate, eluent, elution time, potentials and pulse times: see Example 5.

A repeated input of the relevant starting solutions produced the amounts of substance needed for NMR tests. The appropriately combined fractions were concentrated on a rotary evaporator, microfiltered and freeze-dried.

The invention thus also concerns the individual stereoisomers, preferably in isolated form, of the three said galactosyl isomalts, i.e., in each case the mannitol or sorbitol stereoisomer of β-1,3-, β-1,4- and β-1,6-galactosyl isomalts.

The invention therefore also concerns a method for producing the three galactosyl isomalts in separate form using said method, where the specific galactosyl isomalt that is desired in each case is then purified and separated and isolated from the other two forms and the specific galactosyl isomalt is obtained in isolated form or in a mixture essentially containing it in an amount of, for example, ≧80, ≧90, ≧95 wt % dry substance.

Moreover, the invention also concerns a method for producing the individual stereoisomers of the three galactosyl isomalts, preferably in isolated form, i.e., in each case the mannitol or sorbitol stereoisomer of β-1,3-, β-1,4- and β-1,6-galactosyl isomalts using said method, where the galactosyl isomalt stereoisomer that is specifically desired in each case is purified and separated and isolated from the other forms and the specific galactosyl isomalt stereoisomer is obtained in isolated form or in a mixture that essentially contains it, for example, in an amount of ≧80, ≧90, ≧95 wt % dry substance.

The invention moreover concerns isolated and purified galactosyl isomaltulose mixtures consisting of β-1,3-galactosyl isomaltulose, β-1,4-galactosyl isomaltulose and β-1,6-galactosyl isomaltulose, or that essentially contain them, for example, in an amount of ≧80, ≧90, ≧95 wt % dry substance. The invention likewise concerns isolated β-1,3-galactosyl isomaltulose. The invention also concerns isolated β-1,4-galactosyl isomaltulose. In addition, the invention also concerns isolated β-1,6-galactosyl isomaltulose.

The invention therefore also concerns a method for producing the 3 galactosyl isomaltuloses in separate form using said method, where the specific galactosyl isomaltulose that is desired is then purified and separated from the other two forms and isolated, and the specific galactosyl isomaltulose is obtained in isolated form or in a mixture essentially containing it, for example, in an amount of ≧80, ≧90, ≧95 wt % dry substance.

In another embodiment the invention also concerns the use of said galactosyl isomalt composition (A) and/or galactosyl isomalt composition (B) and/or galactosyl isomaltulose composition and/or the pure substances contained in mixtures in accordance with the invention, hereinafter called products in accordance with the invention, mainly β-1,3-galactosyl isomalt, β-1,4-galactosyl isomalt, β-1,6-galactosyl isomalt, β-1,3-galactosyl isomaltulose, β-1,4-galactosyl isomaltulose, β-1,6-galactosyl isomaltulose, galactosyl lactose, galactosyl lactate and/or galactosyl sorbitol, as well as mixtures of at least two of these as foodstuffs, foods, semi-luxury foods and/or animal feeds, especially with health-promoting, therapeutic and/or prophylactic effects. The invention, however, also concerns the use of said products in accordance with the invention to produce foodstuffs, foods, semi-luxury foods and/or animal feeds, as well as to produce drugs.

Surprisingly, it was found in accordance with the invention that the products in accordance with the invention are not hydrolyzed under the conditions in the stomach or by the enzymes of the small intestine. In a particularly advantageous way, the fermentation of the products in accordance with the invention by probiotics like human bifidobacteria therefore takes place significantly more slowly than in the case of the known prebiotic substances. In an especially advantageous way, this results in the products in accordance with the invention developing their positive effects not only in the anterior segment of the large intestine, but rather over its entire length, even in the posterior segment. In contrast to the preferably used galactose acceptor molecules isomalt and isomaltulose, the products in accordance with the invention pass into the large intestine and, as indigestible carbohydrates, physiologically act as soluble roughages and especially promote intestinal health. As low-molecular oligosaccharides, the products in accordance with the invention, however, do not have the disadvantages of other soluble roughages or indigestible carbohydrates in industrial application.

The products in accordance with the invention are fermentable in the large intestine and by means of the microflora there give rise to the formation of useful fermentation products, especially the advantageous butyric acid, or butyrate. Butyrate is the preferred source of energy of the colon epithelial cells and therefore is decisive for healthy large intestine function. It promotes the growth and differentiation of a healthy epithelium and programmed cell death of (pre)neoplastic cells. Together with other short-chain fatty acids, it reduces mutagenic and other toxic substances in the large intestine lumen and increases the reducing power, i.e., the defensive power, of the body, for example, via the induction of gene expression of protective proteins such as intestinal glutathione S-transferase and the resulting increase of detoxifying cellular reduction equivalents in the form of glutathione. In this way, oxidative stress is reduced. In addition, short-chain fatty acids, including butyrate, reduce the luminal pH and in this way bring about an inhibition of harmful bacterial metabolization activities like β-glucosidases, azoreductases or nitroreductases. Moreover, a low large intestine pH suppresses the harmful intestinal flora and improves growth conditions for positive microorganisms.

Other effects of these fermentation products of the products in accordance with the invention lie in their function as substrates for enhancing the function of the intestinal wall, in reducing toxic luminal substances, in the inducing effect on the intracellular synthesis of the antioxidant glutathione and glutathione S-transferase, in the antiproliferative effect on cancer cells, in the antineoplastic effect and in the ability to increase cell differentiation. The products in accordance with the invention therefore are excellently suitable as agents for treatment and/or prophylaxis of diseases, especially for treatment and/or prophylaxis of diseases that are connected with oxidative stress, cancer diseases and inflammatory intestinal diseases, especially of the region of the large intestine. In addition, the products in accordance with the invention are also capable of blocking pathogenic microbes in particular, because of their interaction with surface structures of these microbes, so that their infectiousness is reduced.

The products made available in accordance with the invention overcome the disadvantages and problems of the prior art and are, in the sense of the invention, suitable agents for promoting health, prophylaxis and treatment of a large number of diseases. In the body, the products in accordance with the invention preferably act directly in accordance with the invention as active agents on cellular macromolecules, and because of this induce a number of functional changes, thus they give rise to a biological effect. It is also provided in accordance with the invention that the decomposition or fermentation products of the products in accordance with the invention function as active agents in the body. The invention therefore also concerns the use of the products in accordance with the invention as a means or active agent for treatment and/or prophylaxis of diseases that can be affected by indigestible carbohydrates.

In connection with this invention, a “disease” or “sickness” is understood to mean disorders of the vital processes and/or states of deficiency in an organism that are accompanied by subjectively perceived and/or objectively establishable physical changes. “Diseases” in accordance with the invention are preferably understood to mean diseases that can be affected by indigestible carbohydrates, as well as infectious diseases, cancer diseases, especially of the region of the large intestine, such as colon carcinogenesis, constipation, hypertension, stroke, diseases caused by pathogenic microbes, rheumatic diseases, osteoporosis, coronary artery diseases, acute cardiac infarct, other cardiac/circulatory diseases, chronic inflammatory diseases, especially of the intestinal region, and inflammatory intestinal diseases.

“Diseases” in accordance with the invention are preferably understood also to mean diseases that are essentially caused by “oxidative stress.” “Oxidative stress” is a condition in which there is an imbalance between the formation and destruction of free radicals in the body or in specific organs or tissues, where “free radicals” are molecules or their fragments and atoms that are characterized by a single unpaired electron and therefore are extremely reactive.

Another preferred embodiment concerns the use of the products in accordance with the invention as means or agents for treatment and/or prevention of constipation, as agents for restoration and maintenance of a healthy microflora and as agents for improving the absorption of nutrient components, especially of minerals like calcium, especially in the animal or human digestive tract, where especially nutritional deficiency phenomena are prevented and/or reduced, and as active agents for prevention and/or treatment of diarrheal diseases, which arise in most infections of the intestine by microorganisms (=bacterial or viral enteritis), for example, traveler's diarrhea caused by enterotoxin-forming E. coli strains as well as other intestinal pathogenic bacteria, viruses, fungi and parasites, also amebic dysentery. Finally, one particularly preferred embodiment concerns the use of the products in accordance with the invention as active agents for enhancing the immune response to general infections, as active agents for prevention of infectious diseases, for prophylaxis of intestinal diseases, for prophylaxis of constipation, for prophylaxis of colon carcinogenesis, for prophylaxis of inflammatory diseases and/or for prop hylaxis of osteoporosis.

Another preferred embodiment of the invention concerns the use of the products in accordance with the invention as pharmaceutical vehicles in a pharmaceutical composition.

Of course, the invention also concerns the use of the products in accordance with the invention to produce pharmaceutical compositions and/or drugs for therapy and/or prophylaxis of said diseases. In connection with this invention, a “pharmaceutical composition” or a “drug” is understood to mean a product or substance mixture in solid, liquid, dissolved or suspended form that is used for diagnostic, therapeutic and/or prophylactic purposes, thus, that promotes or restores the health of a human or animal body, which consists of at least one natural or synthetically produced active agent that gives rise to the therapeutic effect. The pharmaceutical composition can be both a solid and a liquid mixture. For example, a pharmaceutical composition consisting of the active agent can contain one or more pharmaceutically safe excipients. Moreover, the pharmaceutical composition can contain the additives that are usually used in this field, such as stabilizers, production agents, mold release agents, lubricants, slip agents, dyes, fragrances, flavorings, emulsifiers or other substances that are usually used to produce pharmaceutical compositions.

It is provided in accordance with the invention that the products in accordance with the invention are administered in a dosage that is sufficient to prevent the condition of a disease caused by oxidative stress or the condition of an infectious disease, to stop the progression of such a disease, to relieve the symptoms and/or especially to cure the disease. Preferably, the products in accordance with the invention are orally administered, so that they reach the large intestine via the gastrointestinal tract. The dosage of the products in accordance with the invention is dependent, among other things, on the presentation form, the age, sex and weight of the affected organism, especially of the affected human or of an animal that is to be treated, the risk of cancer as well as the severity of the disease. In a preferred embodiment of the invention it is provided that the products in accordance with the invention are administered in the form of a pharmaceutical composition in order to treat and/or prevent diseases or infections. In particular, it is provided that the pharmaceutical composition containing the products in accordance with the invention have the form of an orally administered pharmaceutical composition, especially the form of a suspension, tablet, pill, capsule, granulate, powder or a similarly suitable presentation form. Although the products in accordance with the invention when used in accordance with the invention are insensitive to stomach acid, they can also be contained in drug forms that have a gastric acid-resistant coating. In such drug form the active agents contained in the pharmaceutical composition can pass through the stomach unhindered and are not released until they reach the upper or middle segments of the intestine. The composition of gastric juice-resistant coatings and methods for producing such coatings are known in drug manufacturing. In one especially preferred embodiment of the invention drug forms are used that have a delayed active release mechanism in order to enable longer treatment of diseases. The structure and composition of such drug forms with delayed active agent release are likewise known in the field of drug manufacturing.

It is provided in an especially preferred embodiment of the invention that the pharmaceutical composition containing the products in accordance with the invention be used as part of a combination therapy for treatment, especially for prophylaxis, of diseases. It is therefore provided in accordance with the invention that besides the products in accordance with the invention as active agents, at least one other active agent or at least one other drug for the same indication is administered at the same time. The combined use of the products in accordance with the invention and the minimum of one additional agent or drug can be aimed at enhancing therapeutic or prophylactic effects, but it can also act on different biological systems in the organism and thus enhance the overall effect. The products in accordance with the invention and the minimum of one additional drug can be administered either separately or in the form of fixed combinations. The choice of the additional drug or active agent is mainly dependent on the specific disease to be treated and its severity. If the disease is, for example, a disease that is connected with oxidative stress such as a manifested colon carcinoma, a base chemotherapy optionally prescribed by the physician, for example, using 5-fluorouracil, can be supported by simultaneous administration of the products in accordance with the invention. If the disease is manifested diabetes, the medical treatment of the macroangiopathy in the diabetic using platelet aggregation inhibitors can be supported, for example, by simultaneous administration of the products in accordance with the invention.

In another preferred embodiment of the invention it is provided that the use of the products in accordance with the invention for prophylaxis and/or treatment of diseases of, especially monogastric animals like household pets and domesticated animals, take place by administering the products in accordance with the invention as additives to animal feeds or in their drinking water. It then passes with the ingested food into the digestive tract of the animal, where fermentation by intestinal flora takes place in the region of the large intestine. Administration of the products used in accordance with the invention via food is especially suitable for prevention of disease. With regular feeding of the animal feeds containing the products in accordance with the invention, long-term disease prevention is possible. In connection with this invention, “feeds” or “animal feeds” are understood to mean any substances or substance mixtures that are intended to be fed to animals in unaltered, prepared, adapted or processed state. Animal feeds can be both in liquid and in solid form. The terms “feeds” and “animal feeds” therefore also include modified or supplemented drinking water for animals. Animal feeds can be both single feeds as well as mixed feeds. The active agents in accordance with the invention can be mixed into the animal feed both in dissolved form and in solid form. For administration to domesticated animals like pigs the active agents in accordance with the invention can be mixed into the animal feeds or feed additive mixtures in the form of powders, syrups or granulates. The products used in accordance with the invention can likewise be added to the drinking water for the animals, in accordance with the invention. The addition of the products in accordance with the invention to the drinking water preferably takes place immediately before use by mixing the products in accordance with the invention with drinking water, for example, in the form of powders, syrups or granulates, so that the substances used in accordance with the invention preferably pass into solution rapidly.

In another preferred embodiment of the invention it is provided that the use of the products in accordance with the invention for prevention and/or treatment of said diseases takes place by using the products in accordance with the invention as foods, dietetic foods, as additives to foods, dietetic foods and beverages as well as in drinking water intended for human consumption. The products in accordance with the invention thus pass along with the ingested food or liquid into the digestive tract of the human, where a fermentation by the intestinal microflora takes place in the region of the large intestine. The introduction of the products in accordance with the invention via the food is especially suitable for disease prevention or to prevent infectious diseases. With regular consumption of the foods or beverages containing the products in accordance with the invention long-term prophylaxis and health care are possible.

In connection with this invention, the term “food” is understood to mean chiefly the products or substance mixtures in solid, liquid, dissolved or suspended form that serve for human nutrition and that are chiefly intended to be consumed by humans in unaltered, prepared or processed state. Foods can contain, besides their natural components, other components that can be of natural or synthetic origin. Foods can be in both solid and in liquid form. The term “foods” therefore also includes all types of beverages, including drinking water, that are intended for human consumption. The products used in accordance with the invention can be mixed into foods both in dissolved form and in solid state. A “semi-luxury food” is understood to mean substances or substance mixtures in solid, liquid, dissolved or suspended form that chiefly serve to provide pleasure of the human or animal body upon consumption.

In connection with this invention, “dietetic foods” are understood to mean foods that are intended to serve a certain nutritional purpose such that they bring about the supply of certain nutrients or other nutritional-physiological agents in a specific ratio or in a specific state. Dietetic foods differ decisively from foods of a comparable kind in their composition or their properties. Dietetic foods can be used in cases where certain nutritional requirements must be satisfied due to diseases, functional disorders or allergic reactions to certain foods or their ingredients. Dietetic foods can likewise be both in solid form and in liquid form.

In a preferred embodiment of the invention it is provided that the products in accordance with the invention are used in foods as roughages, especially as soluble roughages or indigestible carbohydrates. In connection with this invention, a “roughage” is understood to mean a component of food, especially the content of indigestible carbohydrates in it, that is indigestible by human or animal enzymes. However, it can also be at least partially fermented by large intestine bacteria and thus be used as a source of energy for the human or animal body to a small extent. “Soluble roughages” is soluble in solutions, especially aqueous solutions. When used as roughages, the products in accordance with the invention regulate the energy density that results from the content of the primary nutrients and regulates the digestion process with regard to transit time and absorption in the small intestine. The products in accordance with the invention are especially suitable as soluble roughage, since because of their very good solubility in water they are present in the large intestine region in dissolved form, and through this can be completely or nearly completely fermented by the intestinal flora. Compared to other commonly used roughages like wheat bran or oat bran, the products in accordance with the invention, when used as roughages, additionally have the advantage that they do not contain substances that lead to undesired side effects.

Another embodiment of the invention concerns the use of the products in accordance with the invention as prebiotic roughages, especially as prebiotics. In connection with this invention, a “prebiotic” is understood to mean a foodstuff, semi-luxury food, animal feed or drug component that selectively stimulates the growth and/or the activity of specific bacteria in the human or animal digestive tract, especially bifidobacteria and/or lactobacilli, so that health-promoting effects can be expected. As a rule, prebiotics are indigestible or only slightly digestible. As a consequence of the fermentation of the products in accordance with the invention to short-chain fatty acids, especially butyrate in a high amount, the use of the products in accordance with the invention leads especially advantageously to a clear decrease of pH into the acid region in the region of the large intestine. Because of this lower pH in the large intestine region, the living conditions for pathogenic intestinal microorganisms are degraded and at the same time the living conditions for acidophilic and saccharolytic microorganisms are improved.

In another improved embodiment the products in accordance with the invention are used in combination with other soluble or insoluble, fermentable or unfermentable roughages. In a preferred variation of this embodiment the products in accordance with the invention are used in combination with at least one other type of roughage chosen from the group of roughages or indigestible carbohydrates consisting of soluble roughages like short-chain fructooligosaccharides, long-chain fructooligosaccharides, galactooligosaccharides, hydrolyzed guar gum such as “Sun Fibre” or “Benefibre,” lactulose, xylooligosaccharides, lactosucrose, maltooligosaccharides such as “Fiber Sol-2” from Matsutani, isomaltooligosaccharides, gentiooligoscaccharides, pectin substances including hydrolases, condensation products of sugars, glucosyl sucrose such as “Coupling Sugar” from Hayashibara, soybean oligosaccharides, chitooligosaccharides, chitosan oligosaccharides and insoluble roughages like resistant starch, oat fiber or wheat fiber, vegetable fiber, for example, from peas or tomatoes, fruit fiber, for example, from apples, berries and fruits of the carob tree, such as “Caromax” from Nutrinova, celluloses and beet fibers such as “Fibrex” from Danisco. Another object of the invention therefore is also roughage containing a galactosyl isomalt composition and/or a galactosyl isomaltulose composition and at least one additional roughage chosen from said roughages group.

Besides mixtures of the products in accordance with the invention with at least one type of said roughages also preferred in accordance with the invention, there are mixtures of the products in accordance with the invention, by themselves or in combination with at least one type of said roughages, with probiotics as “synbiotics.” According to use and presentation form the preferably added probiotic bifidobacteria, lactobacteria and/or enterobacteria cultures are used as living cultures and/or as dry cultures or durable cultures. In connection with this invention, a “synbiotic” is understood to mean a mixture of at least one probiotic and at least one prebiotic, which, by improving the survival rate and increasing the number of health-promoting living microbial organisms in the gastrointestinal tract, promotes the health of the human or animal consumer, especially through active stimulation of the growth and/or metabolic activity of the microbial organisms. An object of the invention is also a synbiotic containing a galactosyl isomalt composition and/or at least one galactosyl isomaltulose composition and at least one probiotic, especially bifidobacteria.

In connection with this invention, a “probiotic” is understood to mean a living microbial component of a food, semi-luxury food, feed or drug that promotes health through stabilization or improvement of the microbial composition in the digestive tract of the human or animal consumer. Such probiotic microorganisms that can be used in foods, drugs or feeds are, for example: bifidobacteria such as the strains B. adolescentis, B. animalis, B. bifidum, B. longum, B. thermophilum; Enterococcus; Lactobacillus such as the strains lb. acidophilus, Lb. brevis, Lb. casei, Lb. cellobiosus, Lb. crispatus, Lb. delbrueckii subsp. Bulgaricus, Lb. fermentum, Lb. GG, Lb. johnsonii, Lb. lactis, Lb. plantarum, Lb. reuteri, Lb. rhamnosum, Lb. salivarius; Bacillus cereus toyoi; Bacillus cereus; Leuconostoc; Pediococcus acidilactici; Propionibacterium; Streptococcus like the strains S. cremoris, S. infantarius, S. intermedius, S. lactis, S. salivarius subsp. thermophilus (see Fuller, J. Appl. Bacteriol. (1989)). Preferred antibiotics are bacteria of the genera Lactobacillus and Bifidobacterium.

The products in accordance with the invention, by themselves or as synbiotics, serve in accordance with the invention as dietetic sources of fiber and/or as nutrients for healthy microflora, for treating and/or preventing constipation, for restoration and maintenance of healthy microflora in the digestive tract, to improve the availability and resorption of nutrient components like minerals in the animal or human digestive tract, generally for support and restoration of health, especially reconvalescence, and as noted above, prevent the development of large intestine tumors and inflammatory intestinal diseases. Preferably, in accordance with the invention, the products in accordance with the invention also serve for modulation and support of the immune system of the animal and human body.

Another preferred embodiment of the invention concerns the use of the products in accordance with the invention for modulation of the glycemic properties of foods or sweets, especially special foods, children's foods or foods for persons with disorders of the glucose/insulin balance, and the glycemic reaction initiated by it. “Glycemic reaction” is understood to mean the change of the blood glucose level after the ingestion of an easily digestible carbohydrate. The strongest glycemic reaction produces carbohydrates from which glucose can be rapidly released and absorbed by enzymes of the saliva, pancreas or small intestine after oral ingestion. An increase of the blood glucose level in the healthy body causes the release of insulin, where the insulin stimulates the uptake of glucose by peripheral tissues, for example, skeletal muscles, so that the blood level falls back to the base value. The products in accordance with the invention can therefore be used for prophylaxis and/or therapy of diabetes mellitus and related metabolic disorders like syndrome X, insulin resistance or glucose intolerance, preferably as a component of dietetic foods and semi-luxury foods. Another object of the invention is the use of the products in accordance with the invention for prophylaxis and/or treatment of disorders of glucose metabolism, diabetes I and II, glucose intolerance, insulin resistance and/or syndrome X.

In another preferred embodiment of the invention provided for the use of the products in accordance with the invention as sweeteners. The products in accordance with the invention have better sweetening properties or sweetening power. They can therefore be used not just as soluble roughages with said related positive properties, but also as sugar substitutes and/or as sweeteners, especially in dietetic products. Since the products in accordance with the invention are not degraded by human oral flora, they have advantageous acariogenic properties. Sweeteners containing the properties in accordance with the invention therefore are advantageously characterized by their acariogenicity. Therefore, an object of the invention is also a sweetener containing the products in accordance with the invention.

Another preferred embodiment of the invention provides for the use of the products in accordance with the invention for production of foods, sweets and animal feeds. In particular, the use of the products in accordance with the invention to produce acidic foods with a pH of 2-5, especially 2-4 is provided. The prebiotic effect of the products in accordance with the invention is supported through such acidic foods. Especially preferably, the products in accordance with the invention are used to produce fruit juices or fruit juice preparations.

This invention likewise concerns foodstuffs, foods and semi-luxury foods that contain the products in accordance with the invention by themselves or in combination with at least one other type of roughage and/or with probiotics. Other objects of the invention are therefore foodstuffs, foods, semi-luxury foods or animal feeds containing a synbiotic, a roughage composition, a galactosyl isomalt composition and/or a galactosyl isomaltulose composition.

It is provided in accordance with the invention that the minimum of at least one other type of roughage is chosen from the group of said soluble or insoluble roughages or indigestible carbohydrates. Since the products in accordance with the invention are essentially not broken down under the pH conditions of the stomach or by the enzymes of the small intestine mucosa, the foodstuffs, foods and semi-luxury foods in accordance with the invention that contain the products in accordance with the invention in effective amounts are advantageously reduced-calorie foodstuffs, foods or semi-luxury foods. In a preferred embodiment of the invention the foods in accordance with the invention are milk items or dairy products, for example, cheese, butter, yogurt, kefir, skim milk, sour milk, buttermilk, cream, condensed milk, dry milk, whey, mixed milk, low-fat milk, mixed whey, milk sugar, milk protein and milk fat products. In another preferred embodiment of the invention the foods in accordance with the invention are baked goods, especially bread, including cookies and fine baked goods including durable baked goods. In other embodiments of the invention the foods in accordance with the invention are sandwich spreads, margarine products and cooking oils as well as instant products and concentrated broth products. In other preferred embodiments of the invention the foods in accordance with the invention are fruit products, especially jams, marmalades, jellies, fruit preserves, fruit pulp, fruit paste, fruit juices, fruit juice concentrates, fruit nectar and fruit powder. The foods containing the products in accordance with the invention can in accordance with the invention also be vegetable products, especially vegetable preserves, vegetable juices and vegetable paste. In other embodiments of the invention the foods containing the products in accordance with the invention are nonalcoholic beverages, sports beverages, beverage bases and beverage powders.

Another preferred embodiment of this invention concerns sweets containing the products in accordance with the invention. The products in accordance with the invention are also used as sugar substitutes and/or as sweeteners in sweets, especially in dietetic products. The sweets in accordance with the invention therefore are advantageously characterized by their acariogenicity. The sweets in accordance with the invention are especially chocolate products, hard caramels, soft caramels, fondant products, jelly products, licorices, marshmallow cream products, coconut flakes, dragees, lollipops, candied fruits, cracknel, nougat products, ice chocolate, marzipan, chewing gum, cereal bars, as well as cooking oils or alcoholic or nonalcoholic sweetened beverages.

Other advantageous embodiments of the invention follow from the subordinate claims.

The invention is illustrated in more detail by means of the following examples.

### EXAMPLE 1

### Preparation of a β-1,3-Galactosyl Isomalt

1.17 mol/L lactose as donor are reacted with β-galactosidase from bull testicle (enzyme amount: 0.75 units) and 1.0 mol/L isomalt (Palatinit®) as acceptor for 48 h at 37° C. in a McIlvain buffer (NaH₂PO₄/citric acid 50 mmol/L) at pH 4.3. A galactosyl isomalt-containing mixture that, with regard to its DP 3 components, exhibits an enrichment of β-1,3-galactosyl isomalt (formula (1)) is obtained.

### EXAMPLE 2

### Preparation of a β-1,4-Galactosyl-Enriched Mixture

### a) Preparation of a β-1,4-Galactosyl Isomalt-Enriched Mixture

0.2 mol/L lactose is reacted with β-galactosidase from Bacillus circulans (enzyme amount: 1.2 units, type: E.C.3.2.1.23, “Biolacta N5,” Daiwa Kasei Co. Ltd., Osaka) and with 1.0 mol/L isomalt for 2 h at 55° C. in a sodium acetate buffer, 50 mmol/L, at pH 5.0. The reaction is stopped by heating for 10 min to 90° C. A galactosyl isomalt is obtained that, with regard to its DP 3 components, has an enrichment of β-1,4-galactosyl isomalt (formula (2)).

Analysis of Reaction Product:

For this, 360.3 mg isomalt (monohydrate), corresponding to 1 mmol, or 10 eq., and 36.0 mg lactose, corresponding to 0.1 mmol, are reacted as described above. The yield is 29.8 mg (0.059 mmol), corresponding to 59%. A white amorphous solid, C₁₈H₃₄O₁₆; MW=506.45; [α]²⁰_{D} +61 (c=0.8, H₂O); MALDI-TOF m/z 529.67 [M+Na]⁺, 545.63 [M+K]⁺ is obtained

¹H-NMR (400MHz, D₂0)

| d, 1 H, J_{1,2}=3.6Hz | d, 1 H, J_{1″,2″}=7.6Hz |
|---|---|
| H-1 | H-1″ |
| 4.79 | 4.29 |

¹²C-NMR (100.67MHz, D₂0)

| Group | C-1 | C-2 | C-3 | C-4 | C-5 | C-6 |
|---|---|---|---|---|---|---|
| Galp-(1→4) | 103.27 | 70.80 | 72.90 | 69.20 | 75.73 | 61.41 |
| Glcp-(1→4) | 98.22 | 71.54 | 71.34 | 78.72 | 72.15 | 60.21 |
| Glcp-ol | 62.79 | 73.25 | n.d. | n.d. | n.d. | 68.92 |
| Manp-ol | 63.63 | n.d. | n.d. | n.d. | n.d. | 68.92 |

Key: 1 Group

### b) Preparation of β-1,4-Galactosyl Isomaltulose-Enriched Mixture

0.2 mol/L lactose is reacted with β-galactosidase from Bacillus circulans and with 1.0 mol/L isomalt for 2 h at 55° C. in a sodium acetate buffer, 50 mmol/L, at pH 5.0. The reaction is stopped by heating for 10 min to 90° C. A galactosyl isomaltulose is obtained that, with regard to its DP 3 components, has an enrichment of β-1,4-galactosyl isomaltulose (formula (5)).

Analysis of Reaction Product:

For this, 342.3 mg isomaltulose, corresponding to 1 mmol, or 10 eq., and 36.0 mg lactose, corresponding to 0.1 mmol, are reacted as described above. The yield is 29.7 mg (0.059 mmol), corresponding to 59%. A white amorphous solid, C₁₈H₃₂O₁₆; MW=504.44; [α]²⁰_{D} +74 (c=0.5, H₂O); MALDI-TOF m/z 526.83 [M+Na]⁺ is obtained.

¹H-NMR (400MHz, D₂0)

| d, 1 H, J_{1,2}=4.1Hz | d, 1 H, J_{1″,2″}=8.1Hz | d, 1 H, J_{3′,4′}=8.1Hz |
|---|---|---|
| H-1 | H-1″ | H-3″ |
| 5.12 | 4.59 | 4.26 |

¹²C-NMR (100.67MHz, D₂0)

| Group | C-1 | C-2 | C-3 | C-4 | C-5 | C-6 |
|---|---|---|---|---|---|---|
| Galp-(1→4) | 103.25 | 70.95 | 72.93 | 68.95 | 75.64 | 61.42 |
| Glcp-(1→4) | 98.42 | 71.47 | 71.35 | 78.71 | 72.07 | 60.31 |
| β-Fruf | 63.02 | 102.10 | 75.74 | 74.92 | 79.27 | 68.36 |

### EXAMPLE 3

### Preparation of a β-1,6-Galactosyl Isomalt-Enriched Mixture

0.2 mol/L lactose is reacted with β-galactosidase from Aspergillus oryzae (enzyme amount: 50 units, type: G 5160, SIGMA Aldrich) and with 1.0 mol/L isomalt for 2 h at 30° C. and pH 4.5 (without buffer). A galactosyl isomalt-containing mixture is obtained that, with regard to its DP 3 components, has an enrichment of β-1,6-galactosyl isomalt (formula (3)).

The table in Example 4 shows the product composition (DP distribution) of the resulting galactosyl isomalt-containing mixtures.

### EXAMPLE 4

### Chromatographic Separation of the Galactosyl Isomalt Mixtures (see Examples 1-3)

The DP distribution of the reaction products from Examples 1-3 was determined by gel permeation chromatography on Fractogel® HW 40 S at 50° C. with demineralized water as eluent, using Raftilose®ST as comparison substance.

| | |
|---|---|
| Reaction of isomalt and | % area |

| lactose with | DP 1 | DP 2 | DP 3 | DP 4 |
|---|---|---|---|---|
| β-1,6-Galactosidase from | 13.9 | 83.9 | 2.2 | — |
| Aspergillus oryzae | | | | |
| β-1,4-Galactosidase from | 5.8 | 80.6 | 11.8 | 1.8 |
| Bacillus circulans | | | | |
| β-1,3-Galactosidase from | 8.7 | 85.0 | 6.3 | |
| bull testicle | | | | |

Oligosaccharides (DP 3, DP 4) were formed in all cases under the chosen incubation conditions.

### EXAMPLE 5

### Galactosyl Isomalts DP 3/DP 4 Hydrolysis

Hydrolyses of the components from regions DP 3 and DP 4 obtained from Examples 1-3 were carried out in 0.5% solutions, 1 mol/L HCl, at 95° C. for 3 h. The analyses were carried out by HPAEC under the following conditions:

| | |
|---|---|
| Separation columns: | 2 × Carbopac PA 1, 4 mm × 250 mm |
| | each, precolumn PA |
| | 1.4 mm × 50 mm, |
| | Anion exchanger, Dionex Co. |
| Eluent: | 0.16 mol/L NaOH with 0.5 mol/L Na acetate |
| | gradients 1-54% in [sic] |
| Elution time: | 30 min |
| Flow rate: | 1 mL/min |
| Detection: | Pulsed amperometric detector (gold electrode). |
| Potentials E and | E₁ = 0.05 V and t₁ = 400 ms, |
| pulse times t: | E₂ = 0.6 V and t₂ = 300 ms, |
| | E₃ = 0.60 V and t₃ = 240 ms |

Content analysis, HPAEC (data in mg/L):

| | | | | | | Sorbitol + |
|---|---|---|---|---|---|---|
| | | | | | | mannitol + |
| Reaction with | | Man- | 1,6- | 1,1- | Glucose + | glucose + |
| β-galactosidase | Sorbitol | nitol | GPS | GPM | Galactose | galactose |
| β-1,6 from Asp. | 200.2 | 174.0 | 32.3 | 29.0 | 1196.8 | 1/3.2 |
| oryzae DP 3 | | | | | | |
| β-1,4 from Bac. | 489.0 | 319.6 | 60.9 | 48.3 | 3378.9 | 1/4.2 |
| circulans DP 4 | | | | | | |
| β-1,4 from Bac. | 840.5 | 49.3 | 104.7 | 75.5 | 3377.5 | 1/2.8 |
| circulans DP 3 | | | | | | |
| β-1,3 from bull | 347.5 | 262.5 | 52.5 | 49.8 | 3656.4 | 1/3.0 |
| testicle DP 3 | | | | | | |

Hydrolysis of the isolated DP 3/DP 4 products produces the monosaccharides sorbitol, mannitol, glucose and galactose, and in addition, small amounts of the cleavage products 1,6-GPS and 1,1-GPM. The ratios of sorbitol plus mannitol to glucose plus galactose indicate a principle formation of galactosyl isomalt.

### EXAMPLE 6

### Reactions with Thermophilic β-Galactosidases

The genes in coding β-galactosidase derived from the three thermophilic microorganisms

| | |
|---|---|
| Bacillus stearothermophilus KVE 39 | (BgaB) |
| Thermus brockianus ITI360 | (BgaT) |
| Thermus thermophilus TH125 | (BglT) |

were cloned into E. coli host strains (β-galactosidase negative) in expression vectors and then propagated. The raw extracts of E. coli obtained after cell digestion were partially purified by heat precipitation and used for subsequent incubations.

Batches: One unit β-galactosidase per 0.5 mL batch is added to 1.5 mol/L lactose solution and to 1.5 mol/L solution consisting of 0.2 part lactose and 0.8 part each isomaltulose, 1,6-GPS or 1,1-GPM in 50 mmol/L Na phosphate buffer, pH 6.5, with 0.02% Na azide (NaN₃) and incubated for 16 h at 37° C. while shaking; reaction stop: 95° C., 15 min; HPAEC analyses: see Example 4.

| | % area | | | |
|---|---|---|---|---|
| Donor/acceptor | DP 1 | DP 2 | DP 3 | DP 4 |
| β-Galactosidase BgaT | | | | |
| Lactose | 35.0 | 61.6 | 3.4 | — |
| Lactose/1,6-GPS | 10.2 | 90.3 | 2.7 | — |
| Lactose/1,1-GPM | 6.5 | 90.3 | 2.7 | 0.5 |
| Lactose/Isomaltulose | 5.9 | 91.8 | 1.5 | 0.7 |
| β-Galactosidase BglT | | | | |
| Lactose | 35.1 | 28.3 | 27.9 | 8.7 |
| Lactose/1,6-GPS | 8.5 | 80.3 | 9.1 | 2.1 |
| Lactose/1,1-GPM | 9.3 | 79.9 | 10.8 | — |
| Lactose/Isomaltulose | 8.2 | 79.1 | 11.3 | 0.8 |
| β-Galactosidase BgaB | | | | |
| (Wild type) | | | | |
| Lactose | 57.7 | 37.6 | 4.7 | — |
| Lactose/1,6-GPS | 15.0 | 85.0 | — | — |
| Lactose/1,1-GPM | 19.0 | 81.0 | — | — |
| Lactose/Isomaltulose | 12.4 | 85.4 | 2.2 | — |

The β-galactosidases BgaT and BglT in the presence of the two isomalt components 1,6-GPS/1,1-GPM and lactose as donor molecule form oligosaccharides. It turned out that both 1,6-GPS and 1,1-GPM function as acceptors. Reactions with isomaltulose and lactose produce in all cases trisaccharides and in some cases tetrasaccharides as well with the β-galactosidases that were used. There is no formation of tri/tetrasaccharides (DP 3, DP 4) in the case of the β-galactosidase BgaB (wild type).

### EXAMPLE 7

### Reactions with Thermophilic β-Galactosidases from Mutants of Bacillus stearothermophilus KVE 39 (BgaB)

The β-galactosidases from BgaB mutants pGP 17 and pGP 23 were prepared and tested by analogy with Example 5.

% area

| Donor/acceptor | DP 1 | DP 2 | DP 3 | DP 4 |
|---|---|---|---|---|
| β-Galactosidase pGP 17 | | | | |
| Lactose | 20.,7 | 70.0 | 9.3 | — |
| Lactose/1,6-GPS | 10.2 | 79.7 | 10.1 | — |
| Lactose/1,1-GPM | 5.4 | 80.0 | 14.8 | — |
| Lactose/Isomaltulose | 10.3 | 82.7 | 7.0 | — |
| β-Galactosidase pGP 23 | | | | |
| Lactose | 26.3 | 58.6 | 15.1 | — |
| Lactose/1,6-GPS | 10.1 | 83.3 | 6.6 | — |
| Lactose/1,1-GPM | 14.1 | 79.5 | 6.4 | — |
| Lactose/Isomaltulose | 12.5 | 81.1 | 6.4 | — |

It turned out that the mutation of the β-galactosidase gene of BgaB leads to enzymes that, in contrast to the wild type, are capable of synthesizing galactosyl isomalt or galactosyl isomaltulose.

### EXAMPLE 8

### Stability of Galactosyl Isomalts in the Stomach and Small Intestine

### a) Stability in the Stomach

The stability of a substance in the gastric passage can be simulated by determining the hydrolysis rate at pH 2.0. Sucrose and 1-kestose are used as controls.

In each case a 1% solution of the trisaccharides (DP 3) from Example 4 is incubated with 10 mmol/L hydrochloric acid, pH 2.0 at 37° C. for 3 h. Samples are taken from the reaction mixture after 60, 120 and 180 min and are analyzed by basic anion exchange chromatography, HPAEC.

| | Incubation time (min) | | | |
|---|---|---|---|---|
| Hydrolysis rate [%] | 0 | 60 | 120 | 180 |
| Sucrose | 0 | 2 | 5 | 8 |
| 1-Kestose | 0 | 11 | 25 | 36 |
| β-1,4-Galactosyl isomalt | 0 | 0 | 0 | <1 |
| β-1,3-Galactosyl isomalt | 0 | 0 | 0 | <1 |
| β-1,6-Galactosyl isomalt | 0 | 0 | 0 | <1 |
| Galactosyl isomaltulose | 0 | 0 | 0 | 2 |

The isolated trisaccharides (DP 3) from the mixtures containing the β-1,3-, β-1,4- and β-1,6-enriched galactosyl isomalt or the isolated galactosyl isomaltulose (BglT) are not hydrolyzed under conditions comparable to the gastric passage when compared to sucrose, with 8% cleavage and 1-ketose with 36% cleavage.

### b) Stability with Respect to Pancreatic Enzymes

The pancreatic secretion contains a large number of hydrolases, including carbohydrate-degrading enzymes like α-amylase, which breaks down α-1,4-glucans (starch, glycogen) preferably to maltose and maltooligosaccharides. The test of the stability of saccharides with respect to pancreatic enzymes is carried out as follows.

3.0 mL of a carbohydrate solution (solution 2 to solution 6) is mixed with 0.1 mL of the enzyme solution (solution 7) per batch:

Solution 1: 20 mmol/L Na phosphate buffer, pH 7.0, with 6 mmol/L NaCl

Solution 2: 1% solution of β-1,4-galactosyl isomalt mixture in accordance with the invention, prepared according to Example 2 and Example 4, in solution 1

Solution 3: 1% solution of β-1,3-galactosyl isomalt mixture in accordance with the invention, prepared according to Example 1 and Example 4, in solution 1

Solution 4: 1% solution of β-1,6-galactosyl isomalt mixture in accordance with the invention; prepared according to Example 3 and Example 4, in solution 1

Solution 5: 1% solution of galactosyl isomaltulose-containing mixture in accordance with the invention, prepared according to Example 6 (BglT) and isolation of trisaccharide by analogy with Example 4, in solution 1

Solution 6: 1% starch solution (soluble starch, according to Zulkowski), in solution 1

Solution 7: 0.2% pancreatin enzyme (Sigma), dissolved in solution 1

After 210 min incubation in a thermomixer (interval shaking) at 37° C., the reaction is stopped by heating to 95° C. for 15 min and the samples are analyzed by HPAEC. The starch-containing sample (solution6+solution 7) is completely hydrolyzed before the HPAEC analysis by heating for 3 h in 1 mol/L hydrochloric acid at 95° C., and the glucose resulting from this is determined in order to calculate the starch content of the sample.

| Substance | Decomposition rate [%] |
|---|---|
| β-1,4-Galactosyl isomalt | <1 |
| β-1,3-Galactosyl isomalt | <1 |
| β-1,6-Galactosyl isomalt | <1 |
| Galactosyl Isomaltulose | <1 |
| Soluble starch | 85 |

The isolated trisaccharides (DP 3) from the β-1,3-, β-1,4- and β-1,6-enriched galactosyl isomalt-containing mixtures and the trisaccharide galactosyl isomaltulose are not broken down by the pancreas enzymes that were used.

### c) Stability with Respect to Small Intestine α-Glucosidases

The enzyme complexes saccharase/isomaltase and glucoamylase/maltase that are present at the mucosa in the small intestine ensure that disaccharides like maltose and sucrose, and in some cases also maltooligosaccharides, that reach the small intestine are broken down to monosaccharides and as such are taken up via the intestinal wall into the blood. The test of the stability of the galactosyl isomalts (DP 3) and galactosyl isomaltulose with respect to these enzymes was carried out as follows.

The enzyme complexes saccharase/isomaltase (SI complex) and glucoamylase/maltase (GM complex) are isolated from pig small intestine by the method of H. Heymann (Dissertation, Hannover, 1991).

Solution 1: 0.1 mol/L triethanolamine (TEA) buffer, pH 7.0

Solution 2: 1% solution DP3 range from β-1,4-galactosyl isomalt mixture prepared according to Example 4, in solution 1

Solution 3: 1% solution DP3 range from β-1,3-galactosyl isomalt mixture prepared according to Example 4, in solution 1

Solution 3: 1% solution DP3 range from β-1,6-galactosyl isomalt mixture prepared according to Example 4, in solution 1

Solution 5: 1% solution of DP3 range of galactosyl isomaltulose-containing mixture prepared according to Example 6 (BglT) and

isolation of trisaccharide by analogy with example 4, in solution 1

Solution 6: 1% solution of maltose in solution 1

Solution 7: 1% solution of sucrose in solution 1

Solution 8: 1% solution of isomalt in solution 1

Solution 9: 1% solution of isomaltulose in solution 1

Solution 10: Saccharase/isomaltase enzyme complex in solution 1

Solution 11: Glucoamylase/maltase enzyme complex in solution 1

i) 0.7 unit of the enzyme complex saccharase/isomaltase (solution 10) or glucoamylase/maltase (solution 11) was added in each case to 1.0 mL of a carbohydrate solution heated to 37° C. (solution 2 to solution 8), mixed and incubated at 37° C.

ii) For incubation under more severe conditions, 16 units of the enzyme complex saccharase/isomaltase or 13 units of the enzyme complex glucoamylase/maltase were used. The reaction was stopped after 2 h by heating to 95° C. for 15 min. The resulting monosaccharides and the undegraded saccharides of the relevant batches were quantitatively determined by HPAEC.

| | 120 min incubation with: | | | |
|---|---|---|---|---|
| | Saccharase/ | | Glucoamylase/ | |
| | Isomaltase | | Maltase | |
| | | More | | More |
| Hydrolysis rate [%] | Standard | stringent | Standard | stringent |
| Sucrose (solution 7) | 85.6 | 91.0 | — | — |
| Maltose (solution 6) | — | — | 92.0 | 96.6 |
| Isomalt (solution 8) | 3.5 | 52.4 | 0 | 12.8 |
| Isomaltulose (solution 9) | 18.0 | 79.0 | 3.1 | 39.9 |
| β-1,4-Galactosyl isomalt | 0 | 7.5 | 0 | 0 |
| β-1,3-Galactosyl isomalt | 0 | 3.2 | 0 | 0 |
| β-1,6-Galactosyl isomalt | 6.9 | 23.7 | 0 | 0 |
| Galactosyl isomaltulose | 0 | 15.0 | 0 | 2 |

Nearly complete hydrolysis of saccharose and maltose by the saccharase/maltase enzyme complex, and of maltose by the glucoamylase/maltase enzyme complex, occurs under the chosen standard conditions. Under these conditions isomalt is partially broken down. The galactosyl isomalts up to β-1,6-galactosyl isomalt (6.9%) are not broken down at all.

Under the more stringent conditions, significant cleavage takes place, in the case of isomalt, 52% for saccharase/isomaltase and 12.8% for glucoamylase/maltase. Galactosyl isomalt and galactosyl isomaltulose are broken down very little under these conditions.

### d) Stability with Respect to Lactase

The enzyme lactase that is present at the mucosa in the small intestine serves in vivo to break down lactose that gets into the small intestine and the resulting monosaccharides are absorbed into the bloodstream through the intestinal wall.

The test of the stability of the galactosyl isomalts (DP 3) and galactosyl isomaltulose with respect to this enzyme is carried out as follows:

The enzyme lactase is isolated in a modified method of Wallenfels, K., and Fischer, J. (Z. Physiologische Chemie 321 (1960) 223).

Solutions 1-5: see Example 8c)

Solution 6: 1% solution of lactose in solution 1

Solution 7: 1% solution of isomalt in solution 1

Solution 8: Lactase in solution 1

0.9 unit of the enzyme lactase is added in each case to 1.0 mL of a carbohydrate solution heated to 37° C. (solutions 2-7), mixed and incubated at 37° C. The reaction is stopped after 6 h by heating to 95° C. for 15 min. The resulting monosaccharides and the undegraded saccharides of the relevant batches are quantitatively determined by HPAEC.

| Hydrolysis rate [%] | Incubation with lactase |
|---|---|
| Lactose | 95.6 |
| β-1,4-Galactosyl isomalt | 13.4 |
| β-1,3-Galactosyl isomalt | 4.8 |
| β-1,6-Galactosyl isomalt | 9.3 |
| Galcatosyl isomaltulose | 7.0 |

Nearly complete hydrolysis of the lactose occurs under the selected conditions. The galactosyl isomalts and galactosyl isomaltulose are only negligibly broken down in comparison to lactose.

### EXAMPLE 9

### Preparation of β-Galactosidases

Bacterial β-galactosidases, which are similar in activity to the β-galactosidase from bull testicle, are especially suitable for the method in accordance with the invention. The following table presents important properties of the enzymes that were used and their origin.

The activity was determined in each case at 65° C. with pNp-β-Gal. Generally a potassium phosphate buffer, pH 6.5, is used for the measurements, and the enzyme preparations are in this buffer. Stable storage takes place at 4° C.

| | | Activity | | | | |
|---|---|---|---|---|---|---|
| | | Units/ | | | | |
| Enzyme | Origin of gene | ml | Units/mg | ml | MW | Purity |
| BgaB | Bacillus | 62.6 | 44.7 | 2 | 78 | ˜60% |
| | stearothermophilius | | | | | |
| | KVE39 | | | | | |
| BgaT | Thermus | 6.4 | 4.6 | 1.5 | 47 | ˜70% |
| | brockianus | | | | | |
| | ITI360 | | | | | |
| BglT | Thermus | 6 | 12 | 2 | 73 | ˜90% |
| | thermophilus | | | | | |
| | TH125 | | | | | |

The temperature optimum for both enzymes from Thermus ssp. is clearly higher (˜90° C.).

The substrate spectrum and regioselectivity of the enzymes was investigated. Pronounced differences for the enzymes were seen.

Various para-nitrophenyl glycosides were used at 65° C. (substrate sufficiently stable here). In the following table the activities are given in % to pNp-β-Gal.

| pNp-Glycoside | Bacillus BgaB | Thermus BgaT | Thermus BgIT |
|---|---|---|---|
| -β-Gal | 100 | 100 | 100 |
| -β-Glc | 0.1 | 3 | 56.2 |
| -β-D-Fuc | 29 | 86.7 | 104 |
| -α-L-Ara | 43 | 34.3 | 6.4 |
| -α-L-Fuc | 0.5 | 0.5 | 0.2 |
| -α-Man | 0 | | |
| -α-Gal | 0.5 | | |
| -α-Glc | 0.4 | | |

These bacterial enzymes, their expression vectors and the genes encoding the enzymes and the cells having the genes or expression vectors, are likewise objects of this invention.

β-Galactosidase Preparations:

A) BgaB from Bacillus stearothermophilus

E. coli strain: pHWG509 in E. coli JM109

Enrichment: Heat precipitation

Activity: pNp-βGal (65° C.): 48 U/mL

Protein: 1.15 mg/mL

B) BgaT from Thermus brockianus ITI360

E. coli strain: pOF3823 in E. coli JM109

Enrichment: Heat precipitation

Activity: pNp-βGal (65° C.): 17 U/mL

Protein: 1.9 mg/mL

C) BglT from Thermus thermophilus TH125

E. coli strain: pHWG475 in E. coli JM109

Enrichment: Heat precipitation

Activity: pNp-βGal (65° C.): 19 U/mL

Protein: 0.9 mg/mL

β-Galactosidase preparations are stored in 0.1 mol/L potassium phosphate buffer, pH 6.5, at 4° C.

### EXAMPLE 10

### Preparation and Characterization of Enzyme Raw Extracts from BgaB Wild Type (pHWG 509) and BgaB Mutants (pGP17 and 23)

All extracts were prepared from 100 mL overnight cultures (ampicillin, rhamnose 0.2%). They were first centrifuged for 10 min at 4° C. at 6000 rpm, the resulting pellet is washed in 10 mmol/L potassium phosphate buffer, pH 6.5. This is followed by centrifuging for 10 min at 4° C. and 6000 rpm. The pellet is dissolved in potassium phosphate buffer, 10 mmol/L, pH 6.5, the cells are digested by means of a French press and centrifuging was carried out at room temperature, 13,000 rpm for 30 min. The supernatant (raw extract) is denatured for 15 min at 60° C., centrifuged for 30 min at room temperature and stored with 0.02 wt % Na azide. A characterization of the enzymes is given below.

To determine the activity, 2 μL raw extract are mixed with 398 μL potassium phosphate buffer, 0.1 mol/L, pH 6.5. It is preincubated for 35 min at 37° C. and 100 μL p-nitrophenyl-β-D-galactopyranoside (4 mg/mL) in potassium phosphate buffer (0.1 mol/L, pH 6.5) are added. The activity is measured for 2 min. The reaction is stopped with 1 mL sodium borate, 0.4 mol/L, pH 4.0, and the quantity of pNP is measured at 405 nm.

Kinetic Parameters for pNPβGal

| | pNPβGal | | Specific |
|---|---|---|---|
| | activity* | Amount of | activity |
| | (μmol/min/mL) | protein (mg) | (μmol/min/mg) |
| pHWG509 | 7.1 | 4.35 | 1.63 |
| (Wild type) | | | |
| pGP17 | 8.0 | 6.90 | 1.16 |
| pGP23 | 5.0 | 7.45 | 0.67 |
| pHWG509 | 3.3 | 1 | 3.30 |
| pGP17 | 13.2 | 20 | 0.66 |
| pGP23 | 5.8 | 19 | 0.30 |

Kinetic Parameters for Oligosaccharides (Values Obtained with a 5 mL Overnight Culture)

| | Vmₐₚₚ | Kmₐₚₚ | |
|---|---|---|---|
| | (U.E./mg) | (mmol/l) | Vmₐₚₚ/Kmₐₚₚ |
| | Disaccharide (Lactose) | | |
| pHWG509 | 1.5 | 6 | 0.25 |
| pGP17 | n.d. | 90 | n.b. |
| pGP23 | 1.5 | 100 | 0.015 |
| | Trisaccharide (Lactosaccharose) | | |
| pHWG509 | 0.84 | 5 | 0.168 |
| pGP17 | n.d. | 180 | n.d. |
| pGP23 | 0.36 | 200 | 0.0018 |

The mutant genes that were prepared, as well as the β-galactosidases encoding for them and vectors and host cells containing them, are objects of the invention.

### EXAMPLE 11

### Fermentation of β-Galactosyl Isomalts in Human Feces

Incubation of carbohydrates with human feces allows statements to be made about the rate of metabolization by the bacterial population and formation of the short-chain fatty acid butyric acid.

To invest the fermentability in an in vitro fermentation experiment, Raftilose® P95 (fructooligosaccharides, DP4-5), galactosyl lactose (Oligomate DP 3) and lactosucrose were used for comparison as carbohydrates of similar structure and degree of polymerization, in addition to β-galactosyl isomalts.

An anaerobic medium of the following composition was used for the in vitro experiments:

Medium 1:

| | | |
|---|---|---|
| Tryptone | 1.5 | g |
| Yeast extract | 1.5 | g |
| KH₂PO₄ | 0.24 | g |
| Na₂HPO₄ | 0.24 | g |
| (NH₄)₂SO₄ | 1.24 | g |
| NaCl | 0.48 | g |
| MgSO₄ × 7H₂O | 0.10 | g |
| CaCl₂ × 2H₂O | 0.06 | g |
| FeSO₄ × 7H₂O | 2.0 | mg |
| Resazurin | 1.0 | mg |
| Cysteine/HCl | 0.5 | g |
| Vitamin solution (as in DSM 141) | 0.5 | g |
| Trace element solution (as in DSM 141) | 9.0 | mL |
| NaHCO₃ | 2.0 | g |
| H₂O, distilled, to 1000 mL, pH 0.7 [sic] | | |

Cultivation of Intestinal Bacteria on the Tested Oligosaccharides:

9 mL of the anaerobic medium 1 described above are mixed with 0.5% (w/v) of the galactosyl isomalts to be tested (prepared according to Examples 1-3) and the corresponding controls lactosucrose and galactosyl lactose and then inoculated with 1 mL of a 10% feces suspension (mixed feces from two subjects) in anaerobic 50 mmol/L phosphate buffer, pH 7.0, to which 0.5 g/L cysteine/HCl was added beforehand as reducing agent.

The batches are then incubated in “Hungate” test tubes for a maximum of 28 h while shaking at 37° C. Samples are taken at various times and tested for content of residual oligosaccharides, short-chain fatty acids, lactic acid and pH.

Result:

The fructooligosaccharide (Raftilose®P95), galactosyl lactose and lactosucrose are nearly completely metabolized after only 7 h. The three different β-galactosyl isomalts prepared according to Examples 1-3, on the other hand, are fermented significantly more slowly, so that after entering into the large intestine, the substances give rise to positive effects farther into the distal region.

| | | | | | Butyrate |
|---|---|---|---|---|---|
| | Incubation time | | | | content (end |
| Degradation rate | 7 | 14 | 22 | 28 | sample) |
| Raftilose ® P95 | 100 | — | — | — | 2.5 mmol/l |
| Galactosyl- | 96.6 | 99.5 | 100 | — | 6.3 mmol/l |
| Lactose (Oligomate | | | | | |
| DP 3) | | | | | |
| Lactosucrose | 98.9 | 100 | — | — | 6.5 mmol/l |
| β-1,3-Galactosyl | 62 | n.d. | 93.6 | 97 | 13.3 mmol/l |
| isomalt | | | | | |
| β-1,4-Galactosyl | 61 | n.d. | 97.7 | 96 | 170. mmol/l |
| isomalt | | | | | |
| β-1,6-Galactosyl | 64.2 | n.d. | 96.1 | 99.2 | 15.3 mmol/l |
| isomalt | | | | | |

The content of butyrate that is formed at the end of the fermentations is about 6 mmol/L for the controls lactosucrose and galactosyl lactose, while there is even less butyrate (2.5 mmol/L) in the fermentation of Raftilose. On the other hand, when β-1,3-, β-1,4-, or β-1,6-galactosyl isomalts are used, metabolization to clearly higher concentrations of butyrate takes place (13.3-17 mmol/L).

### EXAMPLE 12

### Fermentation of β-1,3-Galactosyl Isomalt by Human Bifidobacteria

To investigate the prebiotic and bifidogenic properties of galactosyl isomalt, the growth of various human bifidobacteria was investigated on this substrate in vitro. An anaerobic medium of the following composition was used:

Medium 2:

| | | |
|---|---|---|
| Casein peptone | 10.0 | g |
| Beef extract | 5.0 | g |
| Yeast extract | 5.0 | g |
| Na₂HPO₄ | 1.44 | g |
| NaH₂PO₄ | 0.24 | g |
| K₂HPO₄ | 6.0 | g |
| Tween 80 | 1.0 | g |
| Trace element solution as in DSM 141 | 9.0 | mL |
| Vitamin solution as in DSM 141 | 1.0 | mL |
| Resazurin | 1.0 | mg |
| Cysteine/HCl | 0.5 | g |
| Galactosyl isomalt | 1.0 | g |
| H₂O, distilled, to 1000 mL, pH 7.0 | | |

22 strains of human bifidobacteria were first precultured in “Hungate” test tubes on the above medium 1, in which the source of carbohydrate had first been replaced by glucose (10 g/L). The strains were then inoculated onto medium 2, incubated for 48 h, and then the optical density (E₅₇₈), the pH, the formation of acetate and lactate and the decrease of the β-1,3-galactosyl isomalt concentration were determined.

Result:

Various decomposition paths are distinguished with regard to the metabolization of galactosyl isomalt. Some strains degrade galactose from the substrate with a β-galactosidase and metabolize this monosaccharide (+).

Other strains additionally degrade glucose from the resulting isomalt, in addition to galactose, metabolize both monosaccharides, while this is not true for the resulting mannitol or sorbitol (++). The third group is capable of utilizing galactosyl isomalt as a substrate and also metabolizing mannitol and sorbitol (+++).

It can be seen from the following table to what extent the tested bifidobacteria can utilize galactosyl isomalt as substrate.

| | Growth on β-1,3- |
|---|---|
| Strain of genus Bifidobacterium | galactosyl isomalt |
| B. adolescentis DSM 20083 | +++ |
| B. adolescentis DSM 20086 | +++ |
| B. adolescentis DSM 20087 | +++ |
| B. angulatum DSM 20098 | ++ |
| B. angulatum DSM 20225 | ++ |
| B. bifidum DSM 20082 | + |
| B. bifidum DSM 20215 | + |
| B. bifidum DSM 20239 | + |
| B. bifidum DSM 20456 | − |
| B. breve DSM 20091 | + |
| B. breve DSM 20213 | + |
| B. catenulatum DSM 20103 | ++ |
| B. catenulatum DSM 20224 | ++ |
| B. gallicum DSM 20093 | − |
| B. infantis DSM 20088 | ++ |
| B. infantis DSM 20090 | ++ |
| B. infantis DSM 20218 | − |
| B. infantis DSM 20223 | +++ |
| B. longum DSM 20219 | +++ |
| B. longum DSM 20097 | ++ |
| B. pseudocatenulatum DSM 20438 | ++ |
| B. pseudocatenulatum DSM 20439 | ++ |

−: no decomposition;
+: decomposition and metabolization of galactose from β-1,3-galactosyl isomalt,
++: decomposition and metabolization of galactose and glucose from β-1,3-galactosyl isomalt;
+++: complete decomposition of β-1,3-galcatosyl isomalt.

### EXAMPLE 13

### Hydrogenation of a Galactosyl Isomaltulose-Containing Mixture

500 mL of a galactosyl isomaltulose-containing reaction solution obtained by the reaction of isomaltulose (by analogy with Example 6) with β-galactosidase BglT, diluted to 30% solids, were adjusted to a pH of 7.8 by adding 1N NaOH while stirring. The hydrogenation took place by means of a nickel catalyst (200 g wet mass) in the presence of hydrogen (150 bar) at 70° C. while stirring.

Samples were taken after 0, 1, 2, 3 and 4 h and tested for their content of galactosyl isomaltulose and galactosyl isomalt. The hydrogenation was stopped after quantitative conversion of the free isomaltulose to galactosyl isomalt.

| | Course of hydrogenation [hours] | | | | |
|---|---|---|---|---|---|
| g/l | 0 | 1 | 2 | 3 | 4 |
| Galactosyl isomaltulose | 0 | 14.7 | 6.9 | 2.4 | 0 |
| Galactosyl isomalt | 26.8 | 11.5 | 19.3 | 23.6 | 25.3 |
| Total | 26.8 | 26.2 | 26.2 | 26.0 | 25.3 |

After 4 h reaction time the galactosyl isomaltulose contained in the galactosyl isomaltulose-containing reaction solution was completely hydrogenated to galactosyl isomalt. The solution of the hydrogenated mixture obtained after separation of the catalyst was purified by ion exchange on an H⁺-loaded cation exchanger and an OH⁻ anion exchanger.

### EXAMPLE 14

### Isolation of Galactosyl Isomalt and Galactosyl Lactitol from the Hydrogenated Mixture

200 mL of the hydrogenated solution as in Example 13, diluted to 20% solids, were chromatographed by gel permeation chromatography (Fractogel HW40S, 3 separation columns, each 120 cm long, 10 cm diameter) at 55° C. and a flow rate of 600 mL/h. The fractions of the DP3 range were combined, concentrated and freeze-dried.

The resulting lyophilisate (2.9 g) was used in in vitro analyses for digestibility, fermentability, etc.

### APPLICATION EXAMPLES

The following application examples refer to the use in foodstuffs of galactosyl isomalt-containing compositions that contain at least one galactosyl isomalt chosen from β-1,3-isomalt, β-1,4-galactosyl isomalt and β-1,6-galactosyl isomalt. These mixtures or individual substances are called generally “galactosyl isomalt” in the following.

### Application Example 1

### Sweets

| | Recipe | | | | | | |
|---|---|---|---|---|---|---|---|
| | 1 | 2 | 3 | 4 | 5 | 6 | 7 |
| Gelatine | 10 | 14 | 11 | 0 | 0 | 20 | 15 |
| Water | 20 | 26 | 22 | 80 | 90 | 35 | 30 |
| Sugar | 40 | 35 | 35 | 40 | 50 | 40 | 40 |
| Glucose syrup | 10 | 10 | 40 | 15 | 10 | 40 | 20 |
| Galactosyl isomalt | 25 | 40 | 55 | 20 | 45 | 40 | 20 |
| Fruit acid | 1.3 | 1.6 | 1.4 | 1.0 | 0.6 | 0.5 | 0.7 |
| Glycerol | 1.2 | 4 | 0 | 0 | 4.6 | 0 | 0 |
| Gum Arabic | 0 | 0 | 0 | 80 | 84 | 0 | 0 |
| Cooking temperature | 136 | 136 | 123 | 123 | 121 | 123 | 130 |
| [°] | | | | | | | |

The gelatin is softened or dissolved with water; sugar, glucose syrup and galactosyl isomalt are boiled at the indicated temperature, allowed to cool a little; gelatin, free acid and glycerol are added; the mixture is poured, put into a warming chamber, powdered and oiled.

Gum arabic is dissolved overnight in water, and passed through a hair screen; sugar, glucose syrup and galactosyl isomalt are cooked at the indicated temperature, and allowed to cool a little; the gum solution, glycerol and fruit acid are added; the mixture is molded, put into a warming chamber, powder and oiled.

Jellied fruits:

| | |
|---|---|
| 25 kg | sugar |
| 25 kg | galactosyl isomalt |
| 0.8 kg | agar-agar |
| 30 kg | water |
| 11 kg | apple paste |
| 0.5 kg | tartaric acid |
| 0.06 kg | flavorings, essences or dyes |

The agar is softened in water and dissolved, the sugar and other components are added, and it is cooked at 105° C. The mixture is cast into the appropriate molds.

Recipe

| | 1 | 2 |
|---|---|---|
| Galactosyl isomalt | 3250 | 1500 |
| Sucrose | — | 1500 |
| Glucose syrup | — | 1500 |
| Water | 968.5 | 200 |
| DL-malonic acid | 30 | 30 |
| Flavoring | 6 | 6 |
| Dye | 3 | 3 |

Recipe 1:

Galactosyl isomalt and water are boiled at 160° C. and then vacuum-treated (−0.9 bar). After cooling to 120° C., the pre-dissolved DL-maleic acid, flavoring and dye are stirred in. The melt is stamped out or cast.

Recipe 2:

Sucrose, glucose syrup, galactosyl isomalt and water are boiled at 135° C. and then vacuum-treated. After cooling to 120° C., the pre-dissolved DL malic acid, flavoring are stirred in. The melt is stamped or cast.

| | Recipe |
|---|---|
| Galactosyl isomalt | 164.50 |
| Lycasin 80/55 | 325.00 |
| Water | 32.50 |
| Toffix P | 52.50 |
| Gelatin | 19.50 |
| Monomuls 90-35 | 3.25 |
| Lecithin [g] | 1.30 |
| Calcium carbonate | 50.00 |
| Acesulfame K | 0.33 |
| Aspartame | 0.33 |
| Flavoring | 1.3 |

Galactosyl isomalt, lycasin, sweeteners and water are dissolved; the Toffix, lecithin and Monomuls are stirred in at 120° C.; gelatin, calcium carbonate and flavoring are stirred in at 125° C.; the mixture is molded.

### Application Example 2

### Dog Food

Dog biscuits

| | | |
|---|---|---|
| 150 | g | fresh cheese |
| 90 | g | milk |
| 90 | g | cooking oil |
| 1 | | egg yolk |
| 75 | g | galactosyl isomalt |
| 200 | g | kibble |

The ingredients are mixed, formed into small balls and baked for 20 minutes at 200° C.

Cookies

| | |
|---|---|
| 150 g | whole grain wheat flour |
| 200 g | whole grain oat flakes |
| 30 g | honey |
| 50 g | galactosyl isomalt |
| 5 g | granulated stock mix |
| 100 g | whole egg |
| 150 g | milk |

The ingredients are mixed, formed into balls and baked for 15 minutes at 220° C.

### Application Example 3

### Muesli

Muesli bar

| | | |
|---|---|---|
| 200 | g | oat flakes |
| 100 | g | corn flakes |
| 100 | g | hazelnuts |
| 50 | g | sunflower seed kernels |
| 30 | g | shredded coconut |
| 75 | g | brown sugar |
| 75 | g | honey |
| 100 | g | galactosyl isomalt |
| 50 | g | butter |
| ½ | | lemon |

The sugar, honey, galactosyl isomalt, butter and the juice of the ½ lemon are caramelized. The oat flakes, corn flakes, nuts, sunflower seed kernels and shredded coconut are mixed and added. The mixture is thoroughly mixed and put onto a baking sheet. The bars are cut out and stored dry.

Winter Bircher muesli

| | | |
|---|---|---|
| 4 | EL | oat flakes |
| 2 | EL | millet flakes |
| 1 | EL | wheat germ flakes |

Juice of 1 lemon

| | | |
|---|---|---|
| 150 | g | yogurt |
| 1 | EL | sallow thorn |
| 50 | g | chopped nuts |
| 10 | g | raisins |
| 400 | g | apple |
| 200 | g | pear |
| 300 | g | orange |
| 150 | g | banana |
| 80 | g | galactosyl isomalt |

(EL = slightly rounded tablespoon)

The flakes, yogurt and sallow thorn are mixed together. The nuts are added. The apple is coarsely grated and the other fruits are finely diced, the citrus juice is poured over the apple and the galactosyl isomalt is added.

Summer muesli

| | |
|---|---|
| 150 g | apricots, diced |
| 150 g | low-fat yogurt |
| 40 g | galactosyl isomalt |
| 30 g | corn flakes |

Breakfast cereals

| | |
|---|---|
| 69.3 g | wheat flour type 405 |
| 15 g | oat flour |
| 1 g | light malt |
| 2.1 g | dark malt |
| 0.6 g | salt |
| 10 g | water |
| 12 g | galactosyl isomalt |

The wheat flour, oat flour, light and dark malt, galactosyl isomalt and salt are mixed together. The water is added in the extruder. The dough is mixed there, subject to shear forces, cooked, plasticized and extruded through ring nozzles. Then the rings are dried and cooled.

### Application Example 4

### Beverages

Power Drink

| | | |
|---|---|---|
| 3 | | oranges |
| 2 | EL | wheat germ |
| 35 | g | galactosyl isomalt |
| 200 | g | yogurt |

(EL = slightly rounded tablespoon)

The oranges are squeezed, whisked with wheat germ and galactosyl isomalt and the yogurt is mixed in.

Hobbyist Drink

| | | |
|---|---|---|
| 150 | mL | orange juice |
| 50 | mL | mineral water |
| 1 | pinch | multivitamin powder HT |
| 1 | TL | multimineral powder HT |
| 5 | g | apple-wheat roughage HT |
| 7.5 | g | galactosyl isomalt |

(TL = slightly rounded teaspoon)

Driver 1

| | | |
|---|---|---|
| 200 | mL | rose hip tea |
| 100 | mL | grape juice |
| 5 | g | apple-wheat roughage HT |
| 1 | TL | honey |
| 5 | g | galactosyl isomalt |

(TL = slightly rounded teaspoon)

Driver 2

| | | |
|---|---|---|
| 300 | mL | rose hip tea |
| 5 | g | apple-wheat roughage HT |
| 1 | EL | fresh cheese |
| 100 | mL | grape juice |
| 10 | g | galactosyl isomalt |

(EL = slightly rounded tablespoon)

Choke cherry-apple ballast drink

| | | |
|---|---|---|
| 200 | mL | mineral water |
| 1½ | TL | choke cherry fruit syrup |
| 1 | TL | apple fruit syrup |
| 2 | TL | apple fiber HT |
| 10 | g | galactosyl isomalt |

(TL = slightly rounded teaspoon)

Sports cocktail

| | | |
|---|---|---|
| 2 | | tomatoes |
| ½ | | cucumber |
| 250 | g | carrots |
| 250 | g | apple |
| 4 | EL | cream |
| | | parsley |
| 50 | g | galactosyl isomalt |

(EL = slightly rounded tablespoon)

The tomatoes, cucumber, carrots and apples are juiced, the cream, parsley and galactosyl isomalt are added.

Tomato cocktail

| | | |
|---|---|---|
| 6 | | tomatoes |
| 4 | EL | cream |

Juice of 1 orange

| | | |
|---|---|---|
| 1 | pinch | salt |
| 7.5 | g | galactosyl isomalt |
| 1 | pinch | paprika |
| 2 | dashes | Tabasco |

(EL = about 12 mL)

The tomatoes are pureed and stirred together with the remaining ingredients.

Orange nectar with 50% fruit content

| | | |
|---|---|---|
| 120 | kg | orange nectar base 50:11; |
| | | juice content 400%; extract content 40% |
| 48 | kg | sugar syrup 65% solids |
| 60 | kg | galactosyl isomalt |
| 820 | kg | drinking water |

Lemon soft drink

| | | |
|---|---|---|
| 4.5 | kg | Lemon base 3:100; |
| | | extract content 40% |
| 60 | kg | sugar syrup 65% solids |
| 75 | kg | galactosyl isomalt |
| 888.5 | kg | drinking water |
| 8 | kg | CO₂ |

### Application Example 5

### Fruit Preparations

Red Fruit Desert

| | | |
|---|---|---|
| 330 | g | sour cherries |
| 150 | g | blueberries |
| 300 | g | raspberries |
| 300 | g | strawberries |
| 60 | g | starch |
| 1 | L | fruit juice |
| 60 | g | sugar |
| 50 | g | galactosyl isomalt |

The starch is mixed with a little cold fruit juice and then stirred into the boiling fruit juice. The boiling is continued for 5 minutes. The fruits, sugar and galactosyl isomalt are added.

Cold Rhubarb Soup

| | | |
|---|---|---|
| 750 | g | rhubarb |
| 0.5 | L | water |

Juice of ½ lemon

| | | |
|---|---|---|
| 120 | g | sugar |
| 75 | g | galactosyl isomalt |
| 0.2 | L | white wine |

The rhubarb is washed, chopped and sprinkled with the citrus juice and water. While still warm, it is mixed with the sugar and galactosyl isomalt, cooled and the white wine is stirred in.

Fruit puree

| | | |
|---|---|---|
| 750 | g | fruit |
| 30 | g | fruit juice |
| 50 | g | galactosyl isomalt |
| 3 | mL | rum |

The ingredients are pureed in a mixer.

Strawberry Cream

| | | |
|---|---|---|
| 375 | g | strawberries |
| 50 | g | galactosyl isomalt |
| 1 | packet | vanilla sugar |
| 2 | sheets | white gelatin |
| 2 | sheets | red gelatin |
| 250 | mL | cream |

The berries are pureed, the galactosyl isomalt and vanilla sugar are added, the dissolved gelatin is added and the mixture is chilled. The cream is whipped until stiff and folded in.

Apricot Cream

| | | |
|---|---|---|
| 100 | g | apricots |
| 375 | mL | water |
| 30 | g | sugar |
| 50 | g | galactosyl isomalt |
| 1 | packet | vanilla sugar |
| 4 | sheets | white gelatin |
| 1 | sheet | red gelatin |
| 250 | mL | cream |

The apricots, water, sugar, galactosyl isomalt and vanilla sugar are cooked for 30 minutes. The gelatin is dissolved in the apricot compote, the mixture is pureed and chilled. The cream is whipped until stiff and folded in.

### Application Example 6

### Yogurt

Application Example 6: Yogurt
Yogurt-Lemon Shake

| | | |
|---|---|---|
| 600 | g | low-fat yogurt |

Juice of 4 lemons

| | | |
|---|---|---|
| 4 | TL | honey |
| 30 | g | galactosyl isomalt |
| 4 | | egg yolks |

The ingredients are mixed.

Lemon Yogurt Cream

| | | |
|---|---|---|
| 4 | | eggs |
| 40 | g | sugar |
| 40 | g | galactosyl isomalt |
| 25 | mL | lemon juice |
| 300 | g | yogurt |
| 6 | g | gelatin powder |

The gelatin is softened. The eggs are separated. The yogurt, yolk, sugar, galactosyl isomalt and lemon juice are mixed. The gelatin is dissolved and added. The egg whites are whipped and folded in.

### Application Example 7

### Jam

| Recipe | Gelling sugar | Gelling sugar |
|---|---|---|
| Pectin | 7.370 | 7.370 |
| Citric acid | 10.700 | 10.700 |
| Galactosyl isomalt | 490.965 | 490.965 |
| Sugar | 490.965 | 0.000 |
| Fructose | 0.000 | 490.965 |
| Amount of fruit | 970.000 | 970.000 |

| | | Gelling | Gelling |
|---|---|---|---|
| Recipe | Gelling sugar | sugar | sugar |
| Amidated pectin | 6.41 | 8.00 | 11.55 |
| Citric acid | 3.80 | 3.80 | 3.80 |
| Sorbic acid | 0.63 | 0.63 | 0.63 |
| Galactosyl isomalt | 489.17 | 110.00 | 484.02 |
| Sugar | 0.00 | 377.57 | 0.00 |
| Amount of fruit | 970.00 | 1000.00 | 1455.00 |

Cooking time 4 minutes in each case (except for GZmZ*)

GZmZ: cooling time 5 minutes

*[Abbreviation not found.]

Sour Cherry Jam with Amaretto and Vanilla

| | | |
|---|---|---|
| 1 | kg | sour cherries |
| 3 | | vanilla beans |
| 500 | g | gelling sugar 2:1 |
| 40 | mL | amaretto (almond liqueur) |

Half of the sour cherries are thoroughly chopped in a mixer. The fruit puree is mixed with the remaining cherries. The pulp of the vanilla beans and the gelling sugar are mixed and brought to a boil while stirring. It is boiled at a lively boil for 4 minutes. The amaretto is added. The jam is filled into jars while hot and immediately sealed.

Rhubarb-Strawberry Jam

| | | |
|---|---|---|
| 750 | g | rhubarb |
| 250 | g | strawberries |
| 1000 | g | gelling sugar 1:1 |
| 3 | packets | vanilla sugar |
| 1 | EL | finely chopped lemon balm |

The rhubarb and strawberries are cut into pieces. The fruits are mixed with the gelling and vanilla sugars and steeped 3-4 hours while covered. Then they are brought to a boil while stirring, and boiled for 4 minutes at a lively boil. The lemon balm is stirred in. The jam is filled into jars while hot and immediately sealed.

Pumpkin Jelly

| | | |
|---|---|---|
| 1.5 | kg | pumpkin |
| 1.2 | L | water |
| 1 | kg | gelling sugar 1:1 |

Juice of 2 lemons

| | | |
|---|---|---|
| 1 | TL | chopped mint |

The pumpkin is cut into cubes and cooked until soft with the water for 20-30 minutes. The juice is drained through a towel. 750 mL cold juice are mixed with the gelling sugar and lemon juice and brought to a boil while stirring. It is boiled for 4 minutes at a lively boil. The mint is stirred in. The jelly is filled into jars while hot and immediately sealed.

Strawberry Jam with Grand Marnier

| | | |
|---|---|---|
| 1 | kg | strawberries |
| 1 | kg | gelling sugar |
| 1 | | untreated orange |
| 65 | g | Grand Marnier (orange liqueur) |

The strawberries are mashed, added to the gelling sugar and orange zest, and all are thoroughly mixed. The mixture is brought to a boil while stirring and boiled for 4 minutes at a lively boil. The Grand Marnier is stirred in. The mixture is filled into jars while hot and immediately sealed.

### EXAMPLE 8

### Baked Goods

Yeast is used as the leavening agent in these recipes. The galactosyl isomalt in accordance with the invention can be utilized only marginally as a substrate by baker's yeast. For this reason, only a part of the sugar is replaced with galactosyl isomalt.

Breakfast Croissants

| Component | |
|---|---|
| Yeast | 25 |
| Cream | 250 |
| Sugar | 25 |
| Galactosyl isomalt | 35 |
| Wheat flour type 550 | 400 |
| Salt | 0.15 |
| Margarine | 200 |
| Egg yolk | 50 |

The yeast, lukewarm cream, 1 pinch salt and 1 pinch flour are mixed together. They are allowed to stand for 10 minutes. Then they are kneaded with the other ingredients and left to stand for 20 minutes. The dough is kneaded, rolled out, cut into 15 triangles and rolled into crescent rolls. The rolls are allowed to stand briefly and baked for 10 minutes at 200° C.

White Bread

| Component | |
|---|---|
| Yeast | 40 |
| Sugar | 15 |
| Galactosyl isomalt | 20 |
| Wheat flour type 550 | 1000 |
| Milk | 500 |
| Margarine | 250 |
| Lemon zest | 2.5 |
| Whole egg | 50 |

The yeast is stirred into lukewarm milk along with the sugar and allowed to stand for 10 minutes. It is kneaded with the other ingredients and allowed to stand for 20 minutes. It is baked in a baking pan for 45 minutes at 175° C.

Sesame Bread

| Component | |
|---|---|
| Yeast | 60 |
| Milk | 500 |
| Sugar | 30 |
| Galactosyl isomalt | 45 |
| Wheat flour type 550 | 300 |
| Rye flour type 1150 | 250 |
| Shredded wheat type 1700 | 200 |
| Salt | 0.15 |
| Margarine | 100 |
| Sesame seeds | 100 |

For preparation see white bread.

| | Short crust | Short crust dough |
|---|---|---|
| Component | dough | without sugar |
| Flour | 250 | 250 |
| Sugar | 35 | 0 |
| Galactosyl isomalt | 45 | 90 |
| Salt | 0.15 | 0.15 |
| Chilled margarine | 125 | 125 |
| Whole egg | 50 | 50 |

All of the ingredients are briefly mixed with a blender at the lowest speed and then thoroughly kneaded at a higher speed. The dough is chilled before baking.

| Component | Cake batter | Cake batter without sugar |
|---|---|---|
| Margarine | 125 | 125 |
| Sugar | 65 | 0 |
| Galactosyl isomalt | 90 | 180 |
| Salt | 0.15 | 0.15 |
| Whole egg | 100 | 100 |
| Flour | 250 | 250 |
| Baking powder | 8 | 8 |
| Milk | 125 | 125 |

All the ingredients are mixed together with a beater, first at low speed and then at maximum speed. The two cake batters made in this way show greater browning than a cake batter made with sugar and are less sweet. For this reason it is recommended that the two cake batters listed above be sweetened with a sweetener if necessary.

| | | Sponge cake |
|---|---|---|
| Component | Sponge cake | without sugar |
| Whole egg | 200 | 200 |
| Water | 60 | 60 |
| Sugar | 65 | 0 |
| Galactosyl isomalt | 90 | 180 |
| Flour | 75 | 75 |
| Food starch | 75 | 75 |
| Baking powder | 0.5 | 0.5 |

The egg yolk, water, sugar, galactosyl isomalt and salt are whipped until foamy with a whisk. Stiffly beaten egg white is added to the egg yolk mixture. Flour, food starch and baking powder are mixed together, sieved onto the whipped egg whites and carefully folded in.

### Application Example 9

### Recipes with Galactosyl Isomaltulose

In all of the recipes listed in Application Examples 1-8, the component galactosyl isomalt in the amount given in each case was replaced by an identical amount of the galactosyl isomaltulose in accordance with the invention, and advantageous foodstuffs, foods or semi-luxury foods or animal feeds were also obtained.

1-62. (canceled)

63. A method for producing a composition containing galactosylated isomaltulose, where an aqueous solution of at least one galactosyl donor is brought into contact with at least one β-galactosidase and an aqueous solution of a isomaltulose as galactosyl acceptor, and a galactosyl isomalt composition (A) or a galactosyl isomaltulose composition is obtained, wherein isomalt is a mixture containing 6-O-α-D-glucopyranosyl-(1→6)-D-sorbitol and 1-O-α-D-glucopyranosyl-(1→1)-D-mannitol, and the isomaltulose as galactosyl acceptor is hydrogentated or nonhydrogenated.

64. A method according to claim 63, where the galactosyl donor is lactose.

65. A method according to claim 63, where the β-galactosidase is a β-galactosidase derived from Bacillus circulans, Aspergillus oryzae, bull testicle, Bacillus stearothermophilus KVE39, Thermus brockianus IT1360 or Thermus thermophilus TH125.

66. A method according to claim 63, where the isomaltulose is hydrogenated, and the weight ratio of the galactosyl donor to the mixture containing hydrogenated isomaltulose is from 1:1-1:5.

67. A method according to claim 63, where the contacting is for a time of 1-48 hours or the contacting is at a temperature from 30-55° C., or both.

68. A method according to claim 63, where the galactosyl isomaltulose composition obtained is hydrogenated and a galactosyl isomalt composition (B) is obtained.

69. A method according to claim 68, where the hydrogenation is a catalytic hydrogenation at elevated temperature or elevated pressure, or both.

70. A method according to claim 69, where an aqueous solution containing the galactosyl isomalt composition is adjusted to a pH of 6-8 before the hydrogenation.

71. A method according to claim 69, where the hydrogenation takes place under at least one of the following conditions (a) an elevated temperature of 40-140° C., (b) an elevated pressure of 50-230 bar, (c) a hydrogenation catalyst consisting of a mixture of a pure Raney metal and a Raney metal alloy, and (d) a period of time of 2-5 hours.

72. A method according to claim 71, where the hydrogenation takes place at an elevated temperature of 60-80° C. or an elevated pressure of 100-200 bar, or both.

73. A method according to claim 63, wherein at least one of galactosyl-1,1-GPM, and galactosyl-1,6-GPS is separated from the resulting galactosyl isomalt composition, wherein GPM is 1-O-α-D-glucopyranosyl-(1→1)-D-mannitol dehydrate and GPS is 6-O-α-D-glucopyranosyl-(1→6)-D-sorbitol.

74. A galactosyl isomalt composition comprising galactosyl isomaltulose or galactosyl isomalt, wherein galactosyl isomalt comprises galactosyl-1,1-GPM and galactosyl-1,6-GPS, wherein GPM is 1-O-α-D-glucopyranosyl-(1→1)-D-mannitol dehydrate and GPS is 6-O-α-D-glucopyranosyl-(1→6)-D-sorbitol.

75. A galactosyl isomalt composition according to claim 74 further comprising galactosyl lactsose and at least one of glucose, galactose, lactose, isomaltulose, and a mixture of GPM and GPS.

76. β-1,3-Galactosyl isomalt of the formula selected from the group consisting of 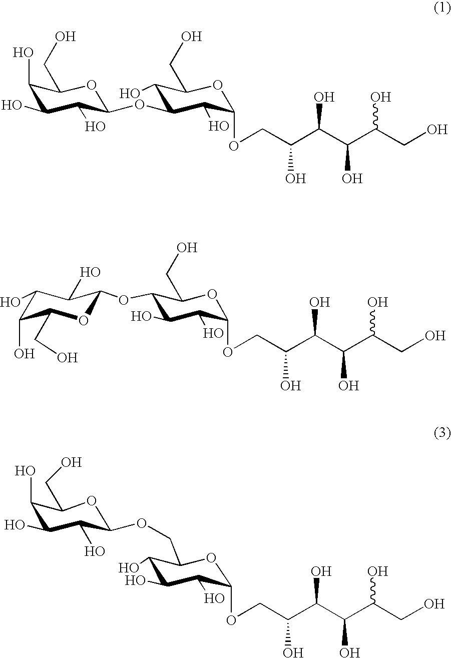
or the sorbitol or mannitol diastereomers thereof.

77. A composition comprising the galactosyl isomalt of claim 75 in which the composition comprises (a) 4-30% by weight β-1,6-galactosyl isomalt of formula 1, (b) 6-60% by weight β-1,4-galactosyl isomalt of formula 2 and (c) 15-90% by weight β-1,3-galactosyl isomalt of formula 3.

78. A galactosyl isomalt composition according to claim 77 additionally containing at least one monosaccharide (DP 1), at least one disaccharide (DP 2), at least one tetrasaccharide (DP 4) or at least one alcohol thereof or a mixture thereof.

79. A galactosyl isomalt composition according to claim 78 where the mixture contains 2-30% by weight monosaccharides (DP 1), 60-90% by weight disaccharides (DP 2), 1-45% by weight galactosyl isomalt of formulas (1), (2) and (3) (DP 3) and up to 5% by weight tetrasaccharides (DP 4).

80. A glactosyl isomaltulose selected from the group consisting of: 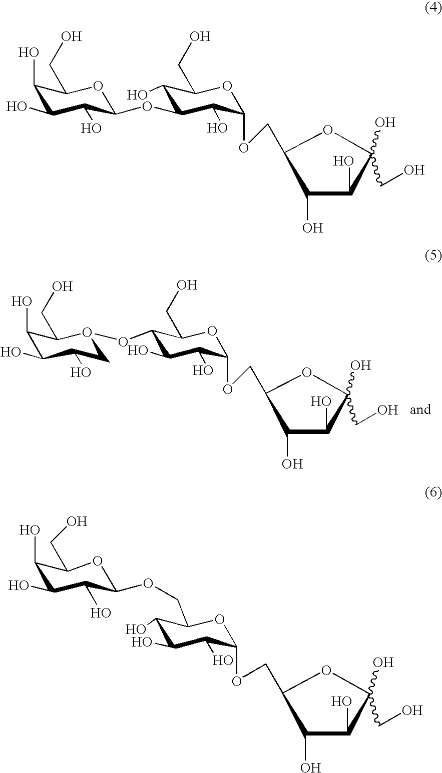
and mixtures thereof

81. A galactosyl isomaltulose composition comprising a galactosyl isomaltulose according to claim 80 and comprising (a) 4-30% by weight β-1,6-galactosyl isomaltulose of formula 4, (b) 6-60% by weight β-1,4-galactosyl isomaltulose of formula 5, and (c) 15-90% by weight β-1,3-galactosyl isomaltulose of formula 6.

82. A galactosyl isomaltulose composition according to claim 81 additionally containing at least one monosaccharide (DP 1), disaccharide (DP 2), tetrasaccharide (DP 4) or alcohol thereof.

83. A galactosyl isomaltulose composition according to claim 82 containing 2-30% by weight monosaccharides (DP 1), 60-90% by weight disaccharides (DP 2), 1-45% by weight, preferably 2-30% by weight, galactosyl isomaltulose of formulas (4), (5) and (6) (DP 3) and up to 5% by weight tetrasaccharides (DP 4).

84. A galactosyl isomaltulose composition according to claim 81containing fuirther comprising at least one of galactose, glucose, lactose, isomaltulose and galactosyl lactose.

85. A galactosyl composition according to claim 74 containing at least one probiotic or roughage.

86. A composition according to claim 85 wherein the probiotic is bifidobacteria, and the roughage is selected from the group consisting of short-chain fructooligosaccharides, long-chain fructooligosaccharides, galactooligosaccharides, hydrolyzed guar gum, lactulose, xylooligosaccharides, lactosucrose, maltooligosaccharides, isomaltooligosaccharides, gentiooligoscaccharides, pectin, hydrolases, condensation products of sugars, glucosyl sucrose, glucosyl sucrose, soybean oligosaccharides, chitooligosaccharides, chitosan oligosaccharides, resistant starch, oat fiber, wheat fiber, vegetable fiber, fruit fiber, celluloses and beet fiber.

87. A composition according to claim 74 in the form of a food, animal feed or pharmaceutical composition.

88. A foodstuff according to claim 87, selected from the group consisting of milk; milk products; sandwich spreads; margarine products and cooking oils; instant products and concentrated broth products; fruit products or preparations; vegetable products or their preparations; flavoring mixtures, muesli and muesli mixtures; beverage bases and beverage powders; sweets; chocolates; caramels; fondant products; jelly products; licorices; marshmallow cream products' coconut flakes; dragees; lollipops; candied fruits; crocant; nougat products; ice chocolate; marzipan; chewing gum; cereal bars; ice cream; and alcoholic or nonalcoholic beverages.

89. In a method of forming a food, animal feed or pharmaceutical composition, utilizing the galactosyl composition according to claim 74.

90. In a method of sweetening a material, utilizing the galactosyl composition according to claim 74 as a sweetener.
